(19) United States
(12) Patent Application Publication
(10) Pub. No.: US 2024/0427321 A1
(43) Pub. Date: Dec. 26, 2024

(54) SYSTEMS AND METHODS FOR DETECTION OF UNKNOWN-UNKNOWNS IN DYNAMICAL SYSTEMS USING STATISTICAL CONFORMANCE WITH PHYSICS-GUIDED PROCESS MODELS

(71) Applicants: Sandeep Gupta, Phoenix, AZ (US); Aranyak Maity, Tempe, AZ (US); Ayan Banerjee, Gilbert, AZ (US)

(72) Inventors: Sandeep Gupta, Phoenix, AZ (US); Aranyak Maity, Tempe, AZ (US); Ayan Banerjee, Gilbert, AZ (US)

(73) Assignee: Arizona Board of Regents on Behalf of Arizona State University, Tempe, AZ (US)

(21) Appl. No.: 18/752,527

(22) Filed: Jun. 24, 2024

Related U.S. Application Data
(60) Provisional application No. 63/522,961, filed on Jun. 23, 2023.

(51) Int. Cl. G05B 23/02; G05B 13/02

(52) U.S. Cl. CPC G05B 23/0254; G05B 13/0265

(57) ABSTRACT

A framework includes a system and associated computer-implemented methods for detecting behavioral changes in a dynamical system that can lead to unsafe conditions before an output of the dynamical system violates a safety threshold, especially for dynamical systems with unmodeled inputs and unmodeled dynamics. In particular, the framework aims to detect “unknown-unknown” errors that may be present in a post-deployment model of the dynamical system that may not be anticipated or modellable by its designers, and are often not directly observable through input-output traces. This is achieved by evaluating conformance of post-deployment model coefficients of the post-deployment model with respect to a set of pre-deployment (ideal) model coefficients. The framework can estimate a future time step where the output of the dynamical system is expected to violate a safety violation based on the post-deployment model.

### CROSS REFERENCE TO RELATED APPLICATIONS

This is a non-provisional application that claims benefit to U.S. Provisional Application Ser. No. 63/522,961, filed on Jun. 23, 2023, which is herein incorporated by reference in its entirety.

### FIELD

The present disclosure generally relates to dynamical systems, and in particular, to a system for checking statistical conformance of a dynamical system by derivation and evaluation of physics-guided process models for the dynamical system from operational traces and model definitions.

### BACKGROUND

Safety-critical cyber-physical systems (CPSs) may encounter operational scenarios that are not accounted for in the design and testing phase. Increasingly these “unknown unknowns” scenarios are observed in practice such as insulin cartridge error in automated insulin delivery systems. Design time safety assurance approaches cannot predict such “unknown unknowns” since the underlying assumed process models preclude occurrences of such scenarios.

It is with these observations in mind, among others, that various aspects of the present disclosure were conceived and developed.

### SUMMARY

A method includes: accessing, at a processor in communication with a memory, model information for a dynamical system including a conformal range that quantifies acceptable deviation of the dynamical system from a set of pre-deployment model coefficients with respect to a safety condition; determining, by a learning model implemented at the processor and based on the model information associated with the dynamical system, a set of post-deployment model coefficients descriptive of post-deployment behavior of the dynamical system based on a set of post-deployment operational trace information obtained through operation of the dynamical system across a plurality of time steps; and identifying, by the processor and based on the set of post-deployment model coefficients, an error time step of the plurality of time steps associated with the set of post-deployment operational trace information, the set of post-deployment model coefficients associated with the error time step being outside of the conformal range.

The learning model can be trained to apply a Physics Guided Surrogate Modeling (PGSM) technique that determines a set of model coefficients for the dynamical system based on a set of operational trace information including a set of input traces and a set of output traces associated with the dynamical system.

The conformal range can incorporate a robustness value that quantifies a degree to which the set of post-deployment model coefficients satisfy the safety condition for the dynamical system, the safety condition being associated with a predefined Signal Temporal Logic function. The model information for the dynamical system can include a predefined Signal Temporal Logic function that defines the safety condition.

The method can further include: determining, by a learning model implemented at the processor, the set of pre-deployment model coefficients for the dynamical system based on a set of pre-deployment operational trace information that are assumed to be error-free, the set of pre-deployment model coefficients corresponding with a joint probability distribution of a set of sample input traces of the set of pre-deployment operational trace information and a set of pre-deployment robustness values over a sample input space.

The method can further include: determining a conformal range based on a confidence interval and a robustness interval obtained using a set of pre-deployment operational trace information for the dynamical system. This step can further include: determining a plurality of residual values associated with a subset of a set of pre-deployment operational trace information for the dynamical system, each residual value of the plurality of residual values respectively incorporating a difference between an average pre-deployment robustness value and an individual pre-deployment robustness value; and determining, using the plurality of residual values with respect to a probability threshold, the confidence interval and the robustness interval.

The method can further include: determining an average set of pre-deployment model coefficients based on the set of pre-deployment operational trace information for the dynamical system by the learning model; and determining the average pre-deployment robustness value based on the average set of pre-deployment model coefficients with respect to a predefined Signal Temporal Logic function that defines the safety condition.

The method can further include: determining an individual set of pre-deployment model coefficients for an input-output trace pair of the subset of the set of pre-deployment operational trace information by the learning model; and determining the individual pre-deployment robustness value for the input-output trace pair based on the individual set of pre-deployment model coefficients with respect to a predefined Signal Temporal Logic function that defines the safety condition.

The dynamical system can incorporate unmodeled control inputs of a user and unmodeled system dynamics associated with the user. In some examples, the dynamical system is an automated insulin delivery system, the set of post-deployment operational trace information being measurable by one or more sensors and having input traces that include an overnight basal insulin level and a glucose appearance rate and having output traces that include a blood glucose level, and the dynamical system incorporating unmodeled control inputs of a user to the automated insulin delivery system and unmodeled system dynamics associated with a physiology of the user that affect correlation between the input traces and the output traces.

In other examples, the dynamical system includes a vehicle control system, the set of post-deployment operational trace information being measurable by one or more sensors and having input traces that include an input control value and having output traces that include an output control value. The vehicle control system can be an aircraft pitch control system, the input control value being an elevator angle and the output control value being a pitch angle. Alternatively, the vehicle control system can be an autonomous vehicle braking system, the input control value correlating with a braking control value and the output control value correlating with vehicle kinematics.

The method can further include: simulating a set of predicted output traces of the dynamical system having the set of post-deployment model coefficients for a plurality of future time steps; identifying a failure time step of the plurality of future time steps having a predicted output trace that violates the safety condition; and estimating a time to failure interval based on a difference between the error time step and the failure time step.

In a further aspect, a method includes: determining, by a learning model implemented at a processor, a set of pre-deployment model coefficients for a dynamical system based on a set of pre-deployment operational trace information, the set of pre-deployment model coefficients corresponding with a joint probability distribution of a set of sample input traces of the set of pre-deployment operational trace information and a set of pre-deployment robustness values over a sample input space, the learning model being trained to apply a Physics Guided Surrogate Modeling (PGSM) technique; determining a conformal range based on a confidence interval and a robustness interval obtained using a set of pre-deployment operational trace information for the dynamical system, the conformal range quantifying acceptable deviation of the dynamical system from the set of pre-deployment model coefficients with respect to a safety condition associated with a predefined Signal Temporal Logic function; and providing the set of pre-deployment model coefficients and the conformal range as model information to a computing device associated with the dynamical system.

The method can further include: determining, by a learning model implemented at a computing device associated with the dynamical system and based on the model information associated with the dynamical system, a set of post-deployment model coefficients descriptive of post-deployment behavior of the dynamical system based on a set of post-deployment operational trace information obtained through operation of the dynamical system across a plurality of time steps; and identifying, by the processor and based on the set of post-deployment model coefficients, an error time step of the plurality of time steps associated with the set of post-deployment operational trace information, the set of post-deployment model coefficients associated with the error time step being outside of the conformal range; the conformal range incorporating the robustness value that quantifies a degree to which the set of post-deployment model coefficients satisfy the safety condition for the dynamical system.

The method can further include: determining a plurality of residual values associated with a subset of a set of pre-deployment operational trace information for the dynamical system, each residual value of the plurality of residual values respectively incorporating a difference between an average pre-deployment robustness value and an individual pre-deployment robustness value; and determining, using the plurality of residual values with respect to a probability threshold, the confidence interval and the robustness interval.

The method can further include: determining an average set of pre-deployment model coefficients based on the set of pre-deployment operational trace information for the dynamical system by the learning model; and determining the average pre-deployment robustness value based on the average set of pre-deployment model coefficients with respect to a predefined Signal Temporal Logic function that defines the safety condition.

The method can further include: determining an individual set of pre-deployment model coefficients for an input-output trace pair of the subset of the set of pre-deployment operational trace information by the learning model; and determining the individual pre-deployment robustness value for the input-output trace pair based on the individual set of pre-deployment model coefficients with respect to a predefined Signal Temporal Logic function that defines the safety condition.

In a further aspect, a system can include a processor in communication with a memory and a dynamical system device, the memory including instructions executable by the processor to: access model information for a dynamical system including a conformal range that quantifies acceptable deviation of the dynamical system from a set of pre-deployment model coefficients with respect to a safety condition; determine, by a learning model and based on the model information associated with the dynamical system, a set of post-deployment model coefficients descriptive of post-deployment behavior of the dynamical system based on a set of post-deployment operational trace information obtained through operation of the dynamical system across a plurality of time steps; and identify, based on the set of post-deployment model coefficients, an error time step of the plurality of time steps associated with the set of post-deployment operational trace information, the set of post-deployment model coefficients associated with the error time step being outside of the conformal range.

### BRIEF DESCRIPTION OF THE DRAWINGS

FIG. 1 is a simplified diagram showing an example system model of a Human-in-Loop Human-in-Plant (HIL-HIP) dynamical system;

FIG. 2 is a flowchart showing a relationship between Errors, Faults, and Hazards of a dynamical system such as the dynamical system of FIG. 1 as studied herein;

FIG. 3 is a simplified diagram showing a comparative analysis between current runtime monitors and an approach to error detection as outlined herein;

FIG. 4 is a diagram showing a two-stage computer-implemented framework for error detection as outlined herein;

FIGS. 5A-5D are a series of graphical representations showing an example Insulin Cartridge Problem in Medtronic 670G studied for validation of the framework of FIG. 4;

FIG. 6 is a graphical representation showing how an unknown-unknown insulin cartridge problem when combined with a known fault of phantom meal violates STL properties for the same input space;

FIG. 7 is a diagram showing an error lattice categorizing different types of errors based on how they are handled in safety certification and operational deployment;

FIG. 8 is a graphical representation showing trajectories for no error, unknown error, and combination of known and unknown error;

FIG. 9 is a diagram showing a framework for Safety Assurance Case Generation for Patch Verification that can implement aspects of the framework of FIG. 4;

FIG. 10 is a process flow diagram showing steps of a first computer-implemented method correlating with the framework of FIG. 4 for evaluating a conformity of a post-deployment model of a dynamical system to a safety condition based on post-deployment model coefficients and identifying an error time step;

FIGS. 11A and 11B are a pair of process flow diagrams showing steps of a second computer-implemented method correlating with the framework of FIG. 4 for obtaining model information for a pre-deployment model of the dynamical system including the conformal range that enables safety evaluation of the post-deployment model;

FIG. 12 is a process flow diagram showing steps of a third computer-implemented method for determining a time to failure interval based on the error time step outputted by the first computer-implemented method of FIG. 10; and

FIG. 13 is a simplified block diagram showing an example computing device for implementation of the framework of FIG. 4 and the methods of FIGS. 10-12.

Corresponding reference characters indicate corresponding elements among the view of the drawings. The headings used in the figures do not limit the scope of the claims.

### DETAILED DESCRIPTION

The present disclosure outlines systems and methods for preemptively identifying ‘unknown-unknown’ errors in AI-enabled autonomous systems (AAS), which arise due to unpredictable human interactions and complex real-world usage scenarios, potentially leading to critical safety incidents through unsafe shifts in operational data distributions. The present disclosure posits that AAS functioning in human-in-the-loop and human-in-the-plant modes must adhere to established physical laws, even when unknown-unknown errors occur. The approaches outlined herein employ constructing physics-guided models from operational data, coupled with conformal inference for assessing structural breaks in the underlying model caused by violations of physical laws, thereby facilitating early detection of such errors before unsafe shifts in operational data distribution occur. Validation across diverse contexts—zero-day vulnerabilities in autonomous vehicles, hardware failures in artificial pancreas systems, and design deficiencies in aircraft in Maneuvering Characteristics Augmentation Systems (MCAS)—demonstrates efficacy of the systems outlined herein in preempting unsafe data distribution shifts due to unknown-unknowns. As such, the systems and methods outlined herein not only advance unknown-unknown error detection in AAS but also sets a new benchmark for integrating physics-guided models and machine learning to ensure safety of a dynamical system.

### I. INTRODUCTION

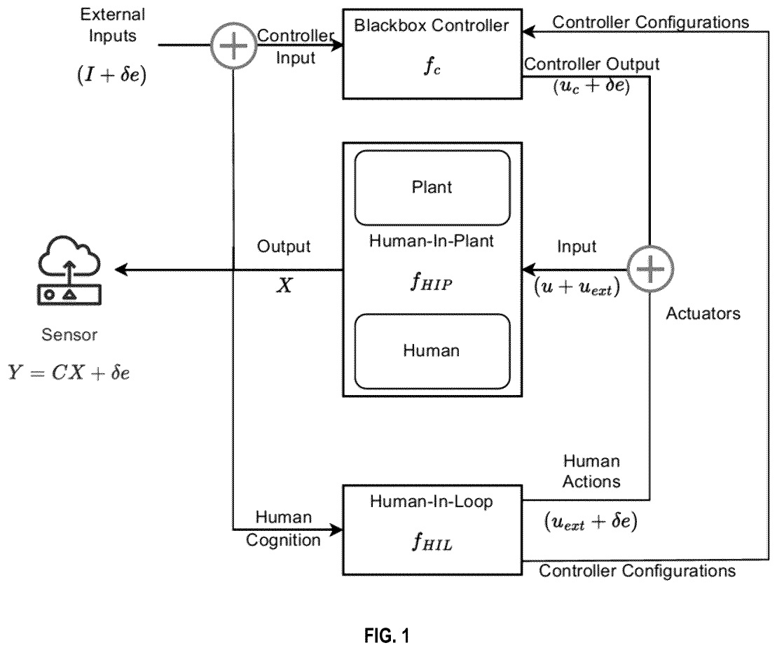

Safety-critical cyber-physical systems (CPSs), often consider a human-in-loop (HIL) architecture. This disclosure considers a class of dynamical systems where the human actively takes part in control (as in HIL systems) but is also a part of the dynamical system that is being controlled as in Human-in-plant (HIP) systems. This dual nature of human participation creates a new class of dynamical systems called HIL-HIP systems described in FIG. 1, which encounter unique challenges due to the stochastic nature of human decisions and may often cause errors that are not accounted for in the design and testing phase. Increasingly, these “unknown unknowns” errors are observed in practice in HIL-HIP systems. Design-time safety assurance approaches are widely used to ensure safe operations of such dynamical systems but, cannot detect such “unknown unknowns” since the approaches don't consider the dynamic nature of the human participants. Existing runtime monitoring algorithms require monitors to be trained on the specific error they are trying to detect which is unavailable in case of unknown-unknown errors. This disclosure focuses on this challenging problem of early detection of unknown-unknown errors in Human-in-Loop Human-in-Plant (HIL-HIP) systems in the operational phase. The goal of the systems and methods outlined herein is the early detection of the unknown-unknowns in the error phase so that they don't cause any safety violations or accidents and the system has enough time to mitigate the errors.

In the architecture shown in FIG. 1, the human operator is integrated both as a part of the control mechanism and within the operational dynamics of the plant itself. The system's behavior is influenced by control inputs delivered concurrently by a black-box controller and a human operator. The plant's state is monitored through sensors and control actions are performed via actuators, processes that are inherently prone to inaccuracies and errors.

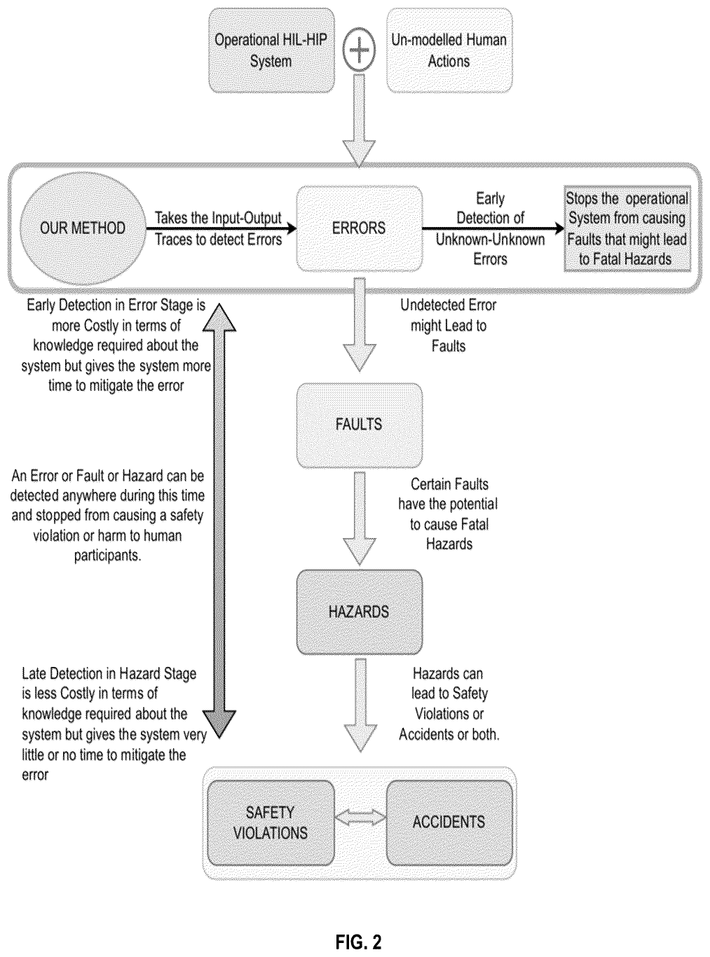

Unknown-unknown errors (Table 1) represent a particular challenge as their causes and impacts on the dynamical system are often unknown. These errors often precipitate a chain of events over time, starting with errors, leading to faults, which may escalate into hazards, and ultimately lead to accidents or safety violations, adversely affecting the human-in-plant (HIP) as in FIG. 2.

Early detection of such errors allows the dynamical system ample opportunity to break the chain of unsafe events. However, early detection is often associated with higher associated costs which calls for a greater comprehension of the dynamical system model. Detection during the fault or the hazard phase often is associated with less cost as the errors have already precipitated in faults or hazards and are observable in the output characteristics but lose valuable time for mitigation. As such, the present disclosure outlines systems and methods that enable the detection of unknown-unknowns in the error stage and stops the errors from evolving into safety violations or accidents.

In the operational phase, sensing is limited, and as such an error in the components of the CPS may not have any effect on the trajectories of the sensed variables. Recently proposed design-time stochastic safety verification based on output trajectories of the CPS implementation may fail to detect errors during operation, since the effect of the errors on the output trajectories (sensor values) may fall within the safe operating conditions. An unknown-unknown error may subsequently be combined with known or unknown errors resulting in safety violations with potentially fatal consequences. Evidence of such safety failure is seen in the case of the Medtronic 670G cartridge problem discussed in more detail in Section I-B. The systems and methods outlined herein combine model conformance with continuous model learning to detect structural breaks in the underlying model driven by the physical laws of the CPS.

TABLE I
Types of Unknown Unknowns explained
in the paper and their causes.

| Name | Domain | Cause of Error |
|---|---|---|
| Toy Example | Linear System | The underlying model of the |
| (Section I-A) | | linear system changed at a |
| | | point in time leading to an |
| | | Unknown-Unknown. (Model |
| | | Change) |
| Insulin | Autonomous Insulin | The Insulin Cartridge |
| Cartridge | Delivery System | malfunctioned leading to a |
| Error | (Artificial Pancreas) | restricted dose of insulin input |
| (Section V-A) | | to the human body. (Actuator |
| | | Error) |
| MCAS Error | Aircrafts and | The Unknown-Unknown |
| in Aircraft | Unmanned Aerial | started from an error in the |
| (Section V-B) | Vehicles | Angle Of Attack sensor in the |
| | | aircraft. (Sensor Error) |
| Braking Failure | Autonomous Vehicle | A zero-day attack was |
| (Section V-C) | | launched on the software of |
| | | the controller code via a |
| | | patching error. (Controller |
| | | Code Vulnerability) |

### A. Rationale for Using Model Conformance to Detect Unknown-Unknowns

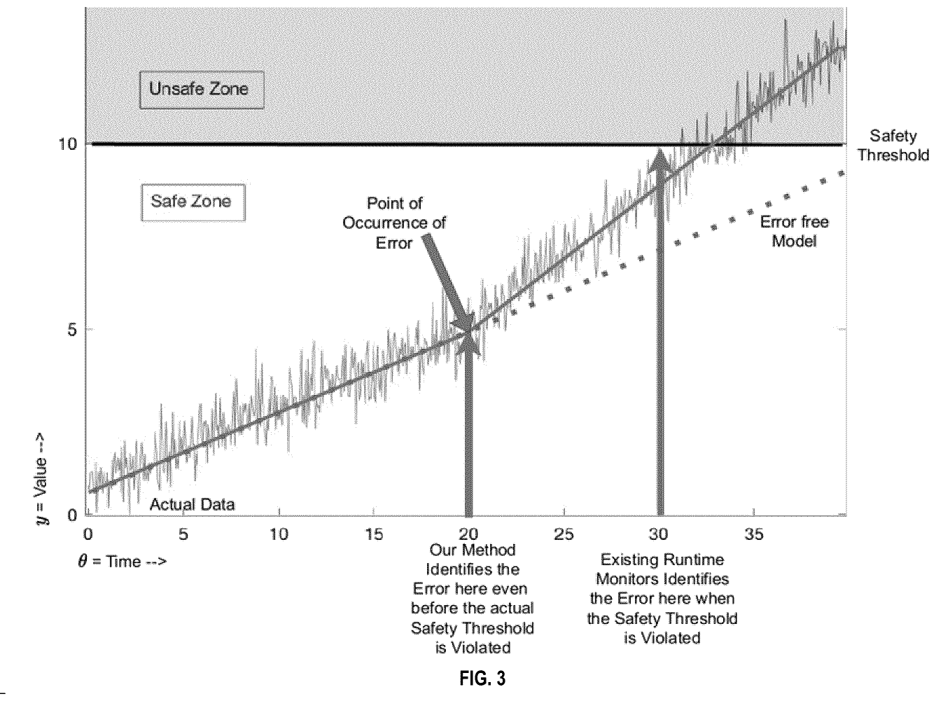

State-of-art fault detection uses runtime monitoring. It involves learning an operational monitor and testing the conformance of the operational data with the monitor's predictions. An unsafe deviation from the monitor predictions is specified using metric logic such as Signal Temporal Logic (STL). The satisfaction of the STL is checked by repeatedly evaluating a robustness value on the operational data. The present disclosure illustrates the inadequacy of such an approach in early error detection using a toy example shown in FIG. 3. While existing techniques can detect errors at 30 when the safety threshold is breached, a framework outlined herein can identify errors at 20, precisely when they occur. In this example, the input θ to the system is time and y is the output of the system.

Consider a dynamical system whose input (θ)-output (y) dynamics is linear, i.e.,

$$y = m θ + c + a w g n \qquad ( 1 )$$

where m=0.2, c=0.9, and awgn is additive white Gaussian noise. In the case of dynamical systems, θ can be considered to be the time variable. The safety is defined by the STL that y never goes beyond 10 for any θ∈[0, 40]. At time θ=20 s, there is an unknown-unknown error, where m changes to 0.4 and c changes to −1.1. As a result of this change y>10 at t=30 s and the dynamical system experiences a hazard.

State-of-art runtime monitoring technique using conformal inference on operational data first learns a model that minimizes the prediction loss in error-free data and then partitions the input space into safe and unsafe regions based on the deviation of operational data from the model predictions. This technique when implemented in the above example (FIG. 3), shows an unsafe region that starts from θ=30.1 based on a sampling rate of 20 Hz.

In contrast, in accordance with embodiments outlined herein, the safety STL m can be converted into an STL on the model coefficients c. In this case, m<0.255 and c>−0.2 for all 0 keeps y<10. Continuous model learning and conformal inference on model coefficients can be combined to partition the input space into safe and unsafe regions based on whether the learned model is violating the safety STL on model coefficients. As such, implementing the strategies outlined herein results in the input segment θ∈[20, 35.05] being annotated as “unsafe”. Note that the unsafe region starts at θ=20, where the original unknown unknown error occurred, while the operational data is still within safe range.

The effects of unknown-unknown errors are often not seen in the output trajectories due to various effects like time delay or damping effects of physical systems. Output trajectories of dynamical systems with unknown-unknown error might still stay within the safety threshold, and existing model conformance techniques are not a viable option for the early detection of errors as these techniques employ model conformance of the input-output trajectories. Model coefficients represent the relationship between the input and the output trajectories of the dynamical system. If an unknown-unknown error affects the dynamical system, it will lead to inaccurate or deviating model coefficients. This is because the model encapsulates the relationship between the input and the output trajectories and if there is an error it would lead to different model coefficients to compensate for the changes in the dynamical system. As such, the present disclosure outlines model conference on model coefficients, rather than on the output trajectories.

### B. Practical Motivation: Cartridge Problem

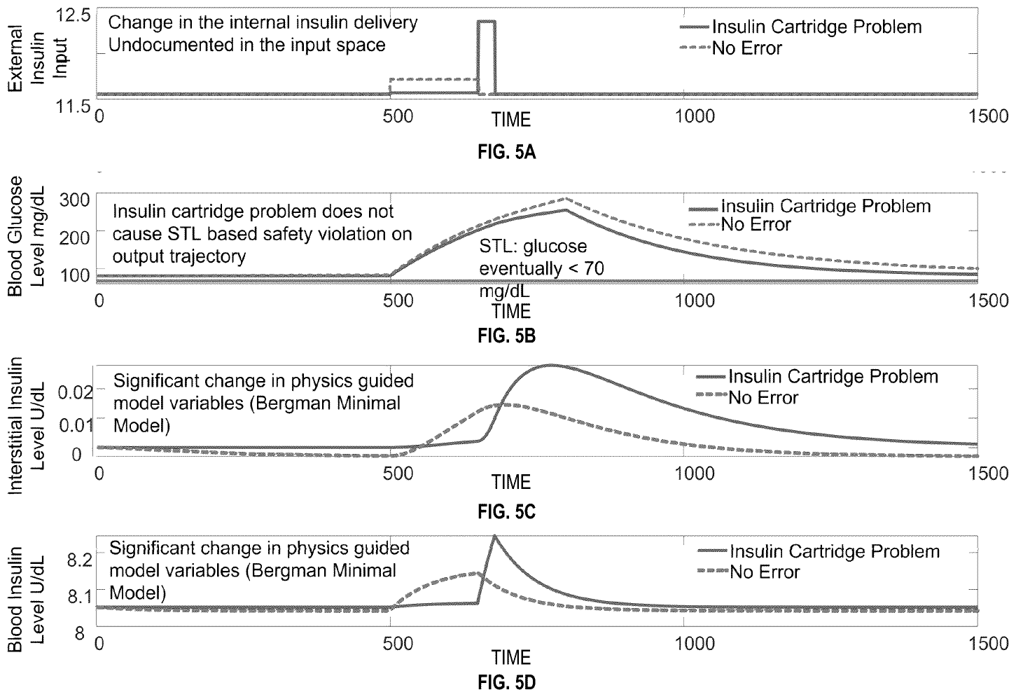

Unknown-unknown errors may potentially change the operational model M(θ), while still maintaining the output trajectory within the robustness confidence interval for the given input space. A case in point is the recent lawsuits on the Medtronic 670G pump. Medtronic 670 G is an FDA-approved automated insulin delivery medical device for Type 1 Diabetic patients to maintain blood glucose levels between upper (hyperglycemia) and lower (hypoglycemic) levels. It exhibited a cartridge problem that changed the trajectory of bolus delivery. Upon an insulin bolus request, a problematic cartridge stunted the supply for an extended period resulting in insulin accumulation. When accumulated insulin reaches a maximum level, it is delivered at a much higher rate than the bolus request (FIGS. 5A-5D, showing that the glucose level does not show any safety violation, although the operational model (solid line) has a significant deviation from the original model (dashed line)). Although Insulin concentration levels in the human body are a state variable, it is not a measured variable. Moreover, the insulin cartridge error occurs after the actuator has decided on an insulin delivery rate and, hence the cartridge error is not reported in the actuator loss. As such this cartridge problem is an internal problem of the Medtronic 670G pump which has no manifestation in the input space Θ. The stochastic safety verification approach cannot identify such a scenario by solely exploring the input space. Moreover, for the given input space, the change in the output trajectory, in this case glucose over time, remains within the robustness threshold and never violates the hypoglycemia safety criteria of ϕ: ζ_{θ}>70 mg/dL.

TABLE II
Symbol Table

| Symbol | Description |
|---|---|
| U2 | Unknown-Unknown Errors |
| [symbol] | Trace of output trajectories. |
| M | Model of the dynamical system under test. |
| θ | Input to the dynamical system |
| Ω | Sequence of model parameters. |
| ρ | Robustness value |
| ϕ | Signal Temporal Logic |
| ψ | Error Factor |
| δ | Distance between the learned model from the original model |
| A | Matrix of coefficients of the model of size n * n |
| B | Diagonal matrix of coefficients of the model of size n * n |
| U(t) | Input Vector of external inputs of size n * 1 |
| [symbol] | Distribution of Inputs |
| λ | Set of Operational Trajectories |
| ω | Coefficients of the Model |
| α | Miscoverage Level |

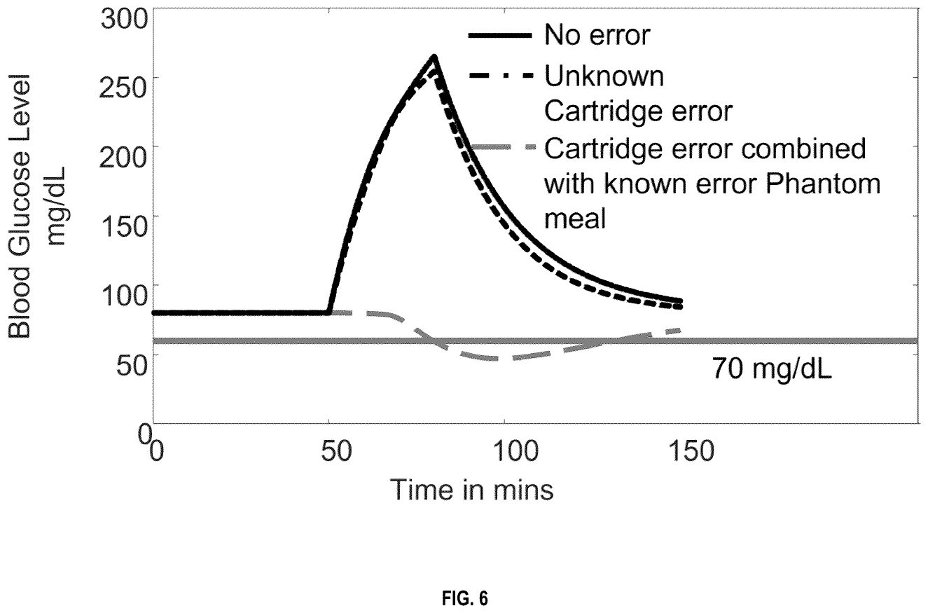

Furthermore, the cartridge problem can be compounded with a phantom meal, where a user attempts to trick the device into providing more insulin by announcing a meal but not ingesting it. Such a fault is consciously generated by the user itself by using the dynamical system in such a manner. When the unknown-unknown error is combined with the known fault, the dynamical system violates the STL-specified safety criteria (FIG. 6) for the same input space for which it was deemed safe. Hence, there are two significant problems with the current stochastic safety verification mechanisms when the safety criteria are specified as an STL formula on the trajectory.
Unknown-unknown errors that result in a fundamental change in the operational model but do not result in a significant change in output trajectory and hence cannot be identified;
Unknown-unknown errors can result in violation of STL specified safety criteria when confounded with a known error or fault.

Further, the present disclosure introduces two new unknown-unknown errors: i) MCAS Error in Boeing 787 Max Aircraft; and ii) Software Vulnerability due to code patching in Autonomous Vehicles. In both these examples, similar error patterns are observed like the Insulin Cartridge Error in the Artificial Pancreas example. In all these errors the cause of the error was unknown and also what effects it might have on the dynamical system was also unknown. For the HIL-HIP system described in FIG. 1, it was not possible to pinpoint the origin of these unknown-unknown errors to a specific source, whether it be an error related to external inputs, a malfunction within the sensors, or a failure in the actuators. Due to this error, there was no significant change in the output trajectories and so traditional error detection algorithms failed to identify them.

### C. Contributions

The present disclosure outlines the following contributions:
Provide a generic framework for stochastic model conformance checking on model coefficients and not on output trajectories.
Use physics-guided surrogate models of CPS to identify changes in operational characteristics due to unknown-unknown errors.
Show use cases on detection of Unknown-Unknown errors as well as time to failure estimation in the artificial pancreas, autonomous vehicles, and aircraft.

### D. Organization

The disclosure is organized in the following pattern. Section II defines the required preliminaries and background work. Section III explains a methodology for mining the model coefficients. Section IV explains how model conformance can be utilized on the model coefficients derived from Section III to evaluate safety of a dynamical system and detect errors before they happen. Section V discusses the case studies used to verify the methods outlined herein. Section VI explains the evaluation criteria and Section VII shows the results of the analysis performed on the examples defined in Section V.

### E. Framework Summary

A framework includes a system and associated computer-implemented method outlined herein detects behavioral changes in a dynamical system that can lead to unsafe conditions before an output of the dynamical system violates a safety threshold, especially for dynamical systems with unmodeled inputs and unmodeled dynamics (such as but not limited to HIL-HIP dynamical systems involving human inputs and dynamics associated with the human body). In particular, the framework aims to detect “unknown-unknown” errors that may be present in a post-deployment model of the dynamical system that may not be anticipated or modellable by its designers, and are often not directly observable through input-output traces.

Current methods have problems in that most are only able to detect errors during run-time when the output of the dynamical system is very close to or has already violated a safety condition. As such, the framework outlined herein aims to detect errors in a post-deployment model of the dynamical system before an output of the dynamical system enters “unsafe” territory. This is achieved by evaluating conformance of post-deployment model coefficients of the post-deployment model with respect to a set of pre-deployment (ideal) model coefficients.

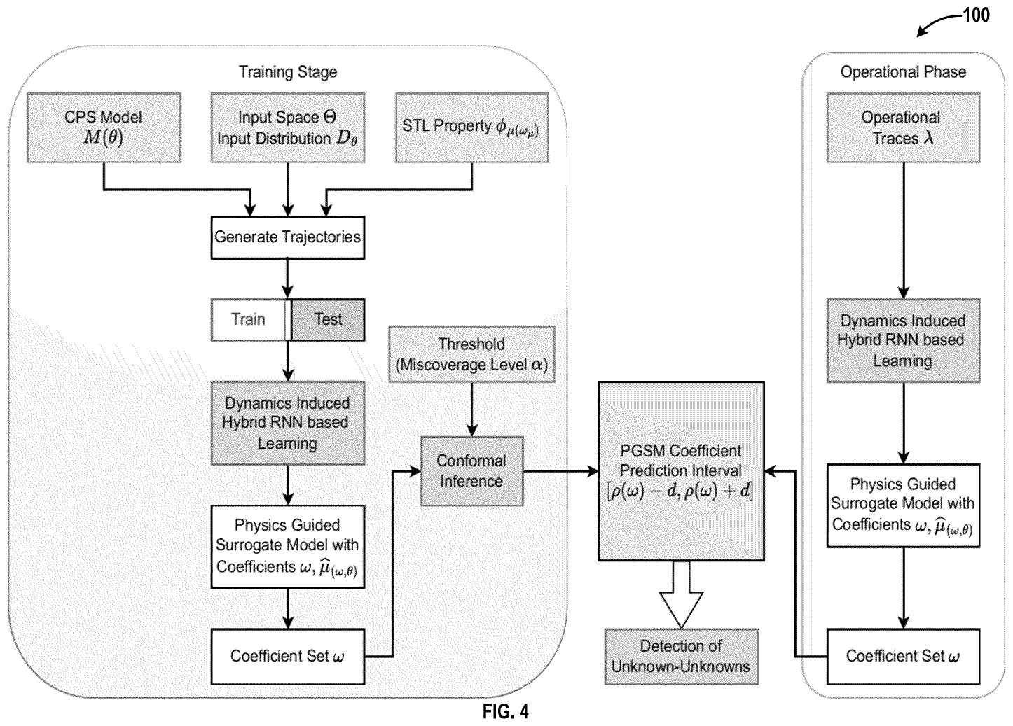

To paraphrase the information outlined herein and with respect to a framework 100 shown in FIG. 4, the framework considers a pre-deployment (ideal) model of the dynamical system as well as a predefined Signal Temporal Logic function (ϕ) that defines a safety condition for behavior of the dynamical system. Model information for the pre-deployment model includes a set of pre-deployment model coefficients (ω) which may be obtained through a learning model (L). The learning model (L) can be trained to determine the pre-deployment coefficients (ω) using a Physics Guided Surrogate Modeling (PGSM) technique. The model information for the pre-deployment model can also include a conformal range ([ρₘᵢₙ−d, ρₘₐₓ+d] where ρₘₐₓ=max_{θ}_{ᵢ}_{∈Θ}(ρ(ϕ, ωᵢ)) and ρₘᵢₙ=min_{θ}_{ᵢ}_{∈Θ}(ρ(ϕ, ωᵢ))) that quantifies how much a post-deployment model of the dynamical system can safely deviate from the pre-deployment model. The model information can be pre-determined by a manufacturer based on a set of pre-deployment operational trace information (which can be assumed to be error-free) that correspond with ideal operation of the dynamical system.

Armed with the model information for the (ideal) pre-deployment model of the dynamical system, the framework allows evaluation of how a post-deployment model of the dynamical system conforms to the safety condition in order to catch and correct errors before they turn into safety violations.

During operation of the dynamical system (e.g., during post-deployment or “real-life” operation), the framework can determine a set of post-deployment coefficients (ω) for the dynamical system based on based on a set of post-deployment operational trace information, which can include a set of input traces (θ) and a set of output traces ((ζ_{θ}) associated with the dynamical system. The post-deployment coefficients (ω) can be obtained through a learning model (L) which may be the same learning model (L) that was used to obtain the pre-deployment coefficients (ω). The learning model (L) can be trained to determine the post-deployment coefficients (ω) using the PGSM technique.

When an error occurs in the post-deployment model, as shown in FIG. 3, the set of post-deployment coefficients (ω) connecting the input traces (θ) to the output traces (ζ_{θ}) present within the set of post-deployment operational trace information may change suddenly. While the change in coefficients may not immediately result in a safety violation, the change in coefficients may precede a future safety violation and can thus be used to identify a time step where an error occurred. As such, the framework can compare the set of post-deployment coefficients (ω) with the set of pre-deployment model coefficients (ω) to identify time intervals where the set of post-deployment coefficients (ω) sufficiently deviate from expected behavior as encoded within the set of pre-deployment model coefficients (ω)

Note that a simple change in coefficients may not necessarily be problematic, as such, the conformal range ([ρₘᵢₙ−d, ρₘₐₓ+d] where ρₘₐₓ=max_{θ}_{ᵢ}_{∈Θ}(ρ(ϕ, ωᵢ)) and ρₘᵢₙ=min_{θ}_{ᵢ}_{∈Θ}(ρ(ϕ, ωᵢ))) may be used as a threshold to evaluate whether a change in the set of post-deployment coefficients (ω) is cause for concern. The conformal range incorporates a robustness value (ρ) that quantifies a degree to which the set of post-deployment model coefficients (ω) can satisfy the safety condition for the dynamical system (e.g., with respect to the predefined Signal Temporal Logic function (ϕ)).

Upon identification of a time step within the set of post-deployment operational trace information that is associated with post-deployment coefficients (ω) that do not satisfy the safety condition for the dynamical system, the framework can estimate a future time step where the output of the dynamical system is expected to violate a safety violation based on the post-deployment model. This allows a user or component of the dynamical system to be informed of the error and take mitigative action to avoid unsafe conditions.

### II. PRELIMINARIES

Definition 1. Trajectory and Models—A trajectory ζ is a function from a set [0, T] for some T∈ [symbol] denoting time to a compact set of values ∈ [symbol] . The value of a trajectory at time t is denoted as ζ(t). Each trajectory is the output of a CPS model M. A model M is a function that maps a k dimensional input θ from the input space Θ⊂ [symbol] to an output trajectory ζ_{θ}.

Definition 2. Trace—Concatenation of p output trajectories over time ζ_{θ}_{₁}ζ_{θ}_{₂} . . . ζ_{θ}_{ₚ} is a trace [symbol] .

Definition 3. Errors—Errors refer to deviations from expected or desired outcomes within a dynamical system. They can arise due to a wide range of factors, including but not limited to human mistakes, equipment malfunctions, software bugs, incorrect data inputs, or unforeseen environmental conditions. The set E defines all the possible errors possible. A specific error Eᵢ∈E={E₁, E₂, . . . , Eₙ}, where n is the total number of possible errors. Each error Eᵢ is defined by a trace [symbol] and is assumed to be uniquely identifiable.

Definition 4. Physics Model—A physics model is a dynamical system expressed using a system of linear time-invariant ordinary differential equations in Equation 2. The system has n variables xᵢ, i∈{1 . . . n} arranged in an n×1 vector χ, [symbol] is an n×n matrices of coefficients, [symbol] is an n×n diagonal matrix of coefficients.

$$\frac{d X ( t )}{d t} = 𝒜 X ( t ) + ℬ U ( t ) , \qquad ( 2 )$$

$$Y ( t ) = β X ( t )$$

where U(t) is a n×1 vector of external inputs. Y(t) is the n×1 output vector of the system of equations. An n×n diagonal matrix, β of 1s and 0s, where βᵢᵢ=1 indicates that the variable xᵢ is an observable output else it is hidden and is not available for sensing. A formal object \hat{μ} is a physics model when the set of models μ can be described using the coefficient ω= [symbol] ∪ [symbol] . The formal object can then take any θ as input and given the model coefficients ω, generate a trace ζ_{θ}=\hat{μ}(ω, θ).

Definition 5. Continuous model mining—Given a trace [symbol] , continuous model mining maps the trace into a sequence Ω of p, ωᵢs such that ∀i dist(\hat{μ}(ωᵢ, θᵢ), ζ_{θ}_{ᵢ})<v, where dist(·) is a distance metric between trajectories and v is a small value decided by the user.

### A. Errors

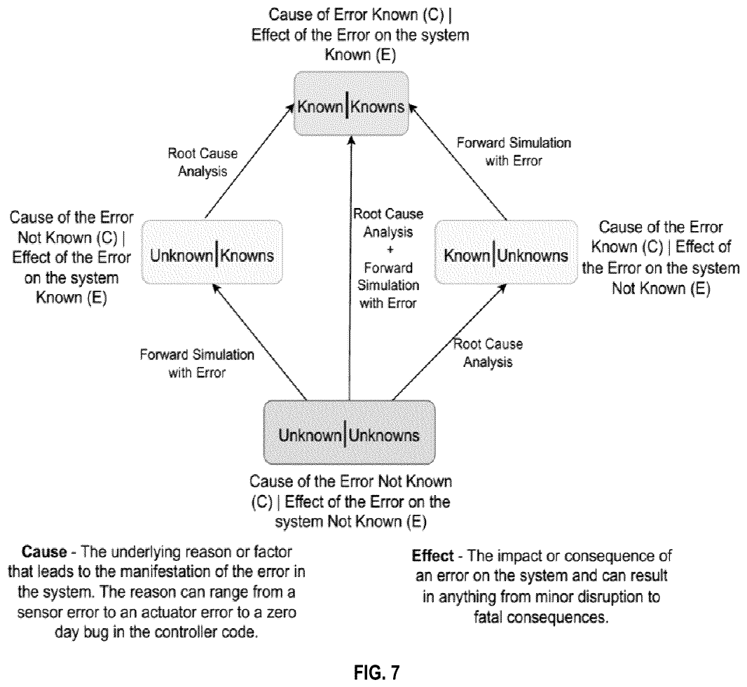

Each type of error is divided based on whether the cause of the error is known and if the effect of the error on the final dynamical system output is known. In (FIG. 7), each node is a tuple {Cause|Effect}, indicating whether (or not) the cause of the error is known Cause, and whether (or not) the effect the error will have on the dynamical system is known Effect. Numerous things might cause errors, including human errors, actuator errors, sensor errors, software bugs, improper data entry, or unanticipated environmental circumstances. The dynamical system model outlined in FIG. 1 illustrates the setup under investigation, incorporating a human participant who is part of the control decisions and also is part of the dynamical system that is being controlled. As detailed in FIG. 1, errors in HIL-HIP systems can stem from errors in the external inputs (I+δe) or due to sensor errors (βX+δe) or from a faulty black-box controller code (where f_{c} has been changed to f′_{c}) or from the dynamic human action model f_{HIL}. These errors can also have multitudinal effects and might cause safety violations of the output or even change the entire operational characteristics of the dynamical system leading to undetected errors.
1) Error Lattice: FIG. 7 explains the lattice representation of the different types of errors discussed. Each node is defined using the following formula.

$$TypeOfError = \{ ( CauseOfTheError ) \vert ( EffectOfTheError ) \} . \qquad ( 3 )$$

2) Types of Errors: Four major categories can be used to categorize errors based on the above definition: i) Known-Knowns; ii) Known-Unknowns; iii) Unknown-Knowns; and iv) Unknown-Unknowns.

Known-Knowns—The cause of the error is known and the effect the error will have on the dynamical system is also known. An example of such an error can be the Angle of Attack (AOA) error in aircraft. These AOA sensors are known to be faulty and malfunction during operation. This error is well-established and the effect the error will have on the dynamical system is also known.

Unknown-Knowns—In these types of errors the actual cause of the error is unknown but what effects the error might have on the dynamical system during real-life operation is known. The problem of phantom braking was unknown-known as the cause of why the phantom braking was happening was unknown but the effect that the car might slow down because of that was known.

Known-Unknowns—The cause of the error is known but what effects it might have on the dynamical system under operation is unknown. The problem of the overheating batteries in Tesla was a known-unknown error, the cause of the error was known but what effects it might have had on the dynamical system was unknown.

Unknown-Unknowns—The error cause is unknown and the possible effect the error will have on the dynamical system is also unknown. Such errors range from the insulin cartridge error in Medtronic insulin pumps where the cause as well as the effect was unknown. Another example of an unknown-unknown error is the failure of plug doors in the Boeing 737 Max 9 flights that led to an emergency landing.

### B. Unknown-Unknowns

Unknown-Unknowns can result from several factors such as human activities that are not modeled, failures in sensors or actuators, or design defects or problems that are overlooked during design time. Numerous definitions of unknown-unknowns, ranging from unknown-unknowns in predictive models to unknown-unknowns in CPS, can be found in the previous works.

Unknown-Unknowns in Predictive Models—Unknown-unknown errors can arise in predictive models where the model gives erroneous predictions with high confidence. These kinds of unknown-unknowns occur from the mismatch between the model training data and the testing dataset. This mismatch may arise from changes between the train and test distributions caused by temporal, geographical, or other variables, such as a little modification in task specification, or from unmodeled biases in the training data collection.

Unknown-Unknowns in CPS Operation—Unknown-unknowns can arise from the multitude of un-modelled states during CPS interaction with the Human-in-Loop or the Human-in-Plant and that can cause fatal scenarios. Because human actions are difficult to model, there are situations that the HIL-HIP systems do not account for. This is one of the main causes of “unknown unknowns” (U2) in CPS safety violations in the operational field.

The present disclosure restricts the U2s to encompass: a) un-modelled human actions, where the user of the CPS provides an input that is not certified safe during test time; b) latent sensor/actuator errors, where a dynamical system component such as a sensor or an actuator fails or encounters faults that are previously unknown; and c) software bugs, where the controller code has some kind of zero-day vulnerability. As a result, despite significant advances in safety engineering, CPS often fails with fatal consequences. Some failures are unintentional, highlighted in recent crash reports from Tesla, lawsuit on Medtronic for their automated insulin delivery (AID) system causing 1 death and 20,000 injuries, and some are intentional, Volkswagen cheating case.

### C. Signal Temporal Logic

Signal temporal logic are formulas defined over trace [symbol] of the form f(Ω)≥c or f(Ω)≤c. Here f: [symbol] → [symbol] is a real valued function and c∈ [symbol] , STL supports operations as shown in Equation 4.

$$ϕ , ψ := true \vert f ( Ω ) \geq c \vert f ( Ω ) \leq c \vert ¬ ϕ \vert ϕ ∧ ψ \vert ϕ ∨ ψ \vert {F}_{I} ϕ \vert {G}_{I} ϕ \vert ϕ {U}_{I} ψ , \qquad ( 4 )$$

where I is a time interval, and F_{I}, G_{I}, and U_{I} are eventually, globally, and until operations and are used according to the standard definitions. A robustness metric can be used to compute or otherwise quantify a degree of satisfaction of the STL.

Definition 6. The robustness value ρ maps an STL ϕ, the trajectory ζ and a time t∈[0, T] to a real value. An example robustness ρ for the STL ϕ: f(Ω)≥c is ρ(f (Ω)≥c, Ω, t)=f(Ω(t))−c.

### D. Problem Statement

Conformance testing is a useful approach in this regard since it can check whether the implementation of a CPS model (or, more generally a dynamical system model) satisfies the safety properties in the runtime. However, during the operational phase, the effects of the unknown-unknown errors are often not readily seen in the output trajectories as discussed in the previous section, and hence, such conformal testing frameworks fail to detect the unknown-unknown errors. The present disclosure explores stochastic conformance of operational output characteristics, λ which is a set of operational trajectories that are generated due to an unknown-unknown error of the CPS with the safety assured process model M. Assume that environmental uncertainty is modeled as an input vector θ that takes values from some set Θ with a distribution [symbol] . The CPS model M(θ) provides output trajectories ζ_{θ} for a sample of inputs θ∈Θ with distribution [symbol] . Further, assume that the output trajectories ζ_{θ} of the model M(θ) do not have any significant error.

In the model conformance process, to evaluate conformance between a CPS model M(θ) and a System-under-test, assume that the system-under-test can be modeled by a formal object \hat{μ} from a set of models μ. This assumption is also called the test assumption. A quantitative property is defined to compare the System-Under-Test and the CPS model M(θ), such as the robustness value ρ of a Signal Temporal Logic (STL) formula as in the case of this paper. The conformance can then be defined using the robustness and a distance function dist that evaluates the difference between the quantitative property of the formal object and the CPS model M(θ). In the present disclosure, it is hypothesized that the CPS model M and the formal object \hat{μ} belong to the same model domain μ and are physics-guided models that represent the operation of the physical system of the CPS using well-established laws of physics, kinematics, fluid dynamics. A deviation due to an unknown-unknown error can be captured if the formal object \hat{μ}also called a surrogate model, can be learned from the operational trajectories λ for the input set θ and compared with M.

The present disclosure instantiates the model conformance process as follows. From the inputs θ and output trajectories ζ_{θ}, coefficients ω of a physics guided δ-surrogate model \hat{μ}(ω, θ) can be mined such that ∃δ: ∀θ∈Θ: dist((ζ_{θ}), \hat{μ}(ω, θ))<δ, for some distance function dist. The robust satisfaction value or robustness of a given Signal Temporal Logic (STL) formula ϕ. Given an STL ϕ and the coefficients ω, the robustness ρ(ϕ, ω) approximates the degree to which ω satisfies the STL. Physics Guided Surrogate Modelling (PGSM) Techniques can be employed to mine ω such that it approximates the joint distribution of θ and ρ(ϕ, ω) over the entire input space Θ if there are no unknown faults. The PGSM model can be used to answer the following questions:
(1) Given a threshold ϵ, and θ˜ [symbol] , does the probability of the PGSM coefficients satisfying the given STL property ϕ, exceed 1−ϵ?

$$( {θ}^{′} \sim {𝒟}_{θ} ) {⇒}^{?} P ( ω ⊨ ϕ ) \geq 1 - ϵ . \qquad ( 5 )$$

(2) Given a threshold ϵ, and θ′˜ [symbol] , and θ′∉θ, can an interval [l, u] be found s.t. the probability that the robustness of PGSM coefficients ω w.r.t the given STL property ϕ, lies in [l, u] exceeds 1−ϵ?

$$( {θ}^{′} \sim {𝒟}_{θ} ) {⇒}^{?} P ( ρ ( ϕ , ω ) ∈ [ l , u ] ) \geq 1 - ϵ . \qquad ( 6 )$$

The conformal inference technique can be employed to evaluate assertions such as Equation 5 and 6. Conformal inference gives a confidence interval for the satisfaction of the assertions with marginal coverage guarantees on the input space.

FIG. 4 shows a framework 100 for measuring behavioral conformity of a post-deployment model with respect to a pre-deployment (ideal) model and identifying a time step associated with an “unknown-unknown” error. During the training stage, the CPS model, the input space, and the Signal Temporal Logic (STL) properties are used to generate trajectories which are in turn used to develop physics guided surrogate models. These models facilitate the determination of a conformal range for the surrogate model coefficients. Subsequently, in the Operational phase, another physics-guided model is learned using real-time operational traces. To ensure the model's conformance, the critical assessment in this phase involves verifying whether the coefficients of this operational model are within the conformal range identified during the training phase.

As such, a first step to the approaches outlined herein is to learn the coefficients of a δ-surrogate PGSM. For this purpose, an input subset θ∈Θ is sampled and their corresponding output trajectories ζ_{θ} are obtained. This set θ is then split into a training set and a test set. Both the training and test sets can then be used to derive the coefficients of the PGSM model.

### E. Learning a Physics Guided Surrogate Model

A surrogate model is a quantitative abstraction of the black box CPS model M. A quantitative abstraction satisfies a given property on the output trajectory of the CPS model. In this disclosure, this quantitative property is the robustness value of an STL property. With this setting, a δ-surrogate model \hat{μ}can be defined:

Definition 7. δ surrogate model: Let ζ_{θ} be a trajectory obtained by simulating M with input θ. Let ω^{T} be the coefficients of the physics guided representation of the original model. The model \hat{μ}(ω, θ) is a δ distance preserving quantitative abstraction if:

$$∃ δ : ∀ θ ∈ Θ : \vert ρ ( ϕ , {ω}^{T} ) - ρ ( ϕ , ω ) \vert < δ \qquad ( 7 )$$

A δ surrogate model guarantees that the robustness value evaluated on a physics model coefficient ω derived from the trajectory ζ_{θ} will not be more than δ away from the robustness computed on the coefficients of the original CPS model M. Obtaining such a model for arbitrary δ is a difficult problem. Hence, a stochastic relaxation of (δ, ϵ)-surrogate model can be defined:

Definition 8. (δ, ϵ)-probabilistic surrogate model: Given a user specified ϵ, a formal object \hat{μ} is (δ, ϵ)-probabilistic surrogate model if:

$$∃ δ ∈ ℛ , ϵ ∈ [ 0 , 1 ] : P ( \vert ρ ( ϕ , {ω}^{T} ) - ρ ( ϕ , ω ) \vert \leq δ ) \geq 1 - ϵ . \qquad ( 8 )$$

### F. Preliminaries of Conformal Inference

Let (X₁, Y₁), (X₂, Y₂), . . . (Xₘ, Yₘ) be i.i.d. in [symbol] × [symbol] drawn from a distribution [symbol] . Consider that a learning mechanism L is used to derive coefficients ωᵢ∈ [symbol] from each Xᵢ such that L(Xᵢ, ωᵢ)=E(Yᵢ|Xᵢ). Consider that the same learning algorithm can be used to derive ωₘ₊₁ for Xₘ₊₁, Yₘ₊₁ with no assumption on [symbol] . Given the quantitative evaluation (robustness) function ρ: [symbol] × [symbol] , conformal inference creates a prediction band C⊂ [symbol] × [symbol] based on (X₁, Y₁), (X₂, Y₂), . . . (Xₘ, Yₘ) for a given α∈{0, 1}, also called the miscoverage level, with the following property:

$$P ( ρ ( {ω}_{m + 1} ) ∈ C ( {X}_{m + 1} , {Y}_{m + 1} ) ) \geq 1 - α , \qquad ( 9 )$$

where C(Xₘ₊₁, Yₘ₊₁)={ωₘ₊₁∈ [symbol] : (Xₘ₊₁, Yₘ₊₁)∈C}.

[symbol]

The learning mechanism minimizes the loss function as shown below:

$$ω = {arg min}_{ω} \frac{1}{m} {\sum }_{1}^{m} {( {Y}_{i} - L ( {X}_{i} , ω ) )}^{2} \qquad ( 10 )$$

Algorithm 1 PredInf({Xᵢ, Yᵢ}ᵢ₌₁^{m}, α, ρ, L)

| | |
|---|---|
| 1: | input Data {Xᵢ, Yᵢ}ᵢ₌₁^{m}, miscoverage level α, robustness ρ, learning |
| | function L |
| 2: | output Confidence range d |
| 3: | Split {1, ..., m} into two equal sized subsets I₁ and I₂. |
| 4: | ω = L((Xᵢ, Yᵢ) : i ∈ I₁) |
| 5: | ωᵢ = L((Xᵢ, Yᵢ) : i ∈ I₂) |
| 6: | Residual Rᵢ = \|ω − ωᵢ\| |
| 7: | d = the k-th smallest value in {Rᵢ : i ∈ I₂}, where k = ┌(m/2 + 1)(1 − |
| | α)┐ |
| 8: | return d |

Split conformal prediction was proposed to construct prediction intervals that satisfy properties such as Equation 9. The prediction process can be encoded in Algorithm 1 PredInf, which takes the i.i.d. training data (X₁, Y₁) . . . (Xₘ, Yₘ), miscoverage level α and the learning algorithm L to provide the prediction interval. The basic method is to divide the training set into two mutually exclusive subsets I₁ and I₂. The learning method is used to derive an average ω for the subset (Xᵢ, Yᵢ)∈I₁. For each element in (Xᵢ, Yᵢ)∈I₂, the learning method is used to derive ωᵢ. The residual ρ(ω)−ρ(ωᵢ) is derived for every element in I₂, and the residual is arranged in ascending order. The algorithm then finds the residual at the position ┌(m/2+1)(1−α)┐. This residual is used as the prediction range d. The prediction interval at a new point (Xₘ₊₁, Yₘ₊₁)) is given by the learning function L such that it satisfies the Theorem 1.

Theorem 1. If ω is a set of coefficients such that L(Xᵢ, ω) and Yᵢ satisfies Equation 10, then for a new ωₘ₊₁ for (Xₘ₊₁, Yₘ₊₁) and a d computed using Algorithm 1, P(ρ(ωₘ₊₁)∈[ρ(ω)−d, ρ(ω)+d])≥1−α.

This confidence interval d can replace the δ in the (δ_{ϵ})-probabilistic surrogate model in Definition 8.

### III. COEFFICIENT MINING FROM TRAJECTORY

Problem Definition 1. Given a set of variables χ(t), a set of inputs U(t), a β vector indicating observability, and a set [symbol] of traces such that ∀i: βᵢ=1∃T(xᵢ)∈ [symbol] and ∀uⱼ(t)∈U(t)∃T(uⱼ)∈ [symbol] .

Derive: approximate coefficients [symbol] and [symbol] such that:
∀i, j| [symbol] (i, j)− [symbol] (i, j)|<ξ
∀i [symbol] (i, i)− [symbol] (i, i)|<ξ
Let [symbol] be the set of traces that include variables derived from the solution to differential equation

$$\frac{dX ( t )}{dt} = {𝒜}^{a} X ( t ) + {ℬ}^{a} U ( t )$$

then ∀i: θᵢ=1, and ∀k∈{1 . . . N}, T^{α}(xᵢ) [k]−T(xᵢ)[k]|<ΨT(xᵢ)[k], where ξ is the error in the coefficient estimator, while Ψ is the error factor for replicating the traces of variables with the estimated coefficients.

For the implementation of coefficient mining from the trajectory, various architectures and techniques can be employed for model recovery, including neural network architectures like LTC-NN, CT-RNN, DiHRNN, or NODE, as well as regression-based techniques like Sparse Identification of Nonlinear Dynamical systems (SINDy).

### IV. CONFORMAL INFERENCE

Conformal inference can be used to quantify the accuracy of a model's predictive capacity. Using a finite number of samples, conformal inference can provide guarantees on the model accuracy irrespective of the data distribution, or the method of model learning. This section discusses the basic idea of conformal inference and it can be employed to measure behavioral conformity of a post-deployment model with respect to a pre-deployment (ideal) model.

A. Computing (d, ϵ) probabilistic PGSM

To apply the conformal inference technique to the problem, the following correspondence can be used: Xᵢ→θᵢ and Yᵢ→dist(\hat{μ}(ω, θ), ζ_{θ}), κ→ω and γ→ρ(ϕ, ωᵢ). To derive a (d, ϵ) PGSM, the input space Θ is sampled for m different samples of θᵢ. The learning algorithm from Section III can be employed to derive ωᵢ from each θᵢ, by using the learning algorithm L(θᵢ, ωᵢ). Then, compute the robustness values ρ(ϕ, ω) for each ωᵢ. Then Lemma 1 follows from Theorem 1.

Lemma 1. For d=PredInt({θᵢ, dist(\hat{μ}(ω, θ), ζ_{θ})}ᵢ₌₁^{m}, α, ρ(ϕ, ·), L) where PredInt is in Algorithm 1, 1−ϵ is a user defined threshold probability, L is the model coefficient learning algorithm, and d∈ [symbol] , then the PGSM \hat{μ}(θ, ω) is a (d, ϵ) probabilistic surrogate model.

The confidence interval d returned by Algorithm 1 can be extended over the entire input space Θ and can be used for the stochastic model conformance process. Theorem 2 shows that the confidence range d returned by Algorithm 1 is a property of the entire input space Θ.

Theorem 2. Let:
1) \hat{μ}(θ, ω) be a PGSM
2) construct (θᵢ, dist(\hat{μ}(ω, θ), ζ_{θ}))) for some ω obtained by a learning algorithm.
3) Let L(θᵢ, ωᵢ) be the learning algorithm that provides a ωᵢ given a θᵢ
4) d=PredInt({θᵢ, dist(\hat{μ}(ω, θ), ζ_{θ})}ᵢ₌₁^{m}, α, ρ(ϕ, ·), L)
5) ρₘₐₓ=max_{θ}_{ᵢ}_{∈Θ}(ρ(ϕ, ωᵢ)) and ρₘᵢₙ=min_{θ}_{ᵢ}_{∈Θ}(ρ(ϕ, ωᵢ))

Then:

$$∀ θ ∈ Θ ⇒ P ( p ( ϕ , ω ) ∈ [ {ρ}_{min} - d , {ρ}_{max} + d ] ) \geq 1 - ϵ . \qquad ( 11 )$$

Proof. The proof of the theorem is a straightforward combination of Theorem 1 along with the definition ρₘₐₓ and ρₘᵢₙ in step (5) of Theorem 2.

Equation 11 is the type of stochastic conformance guarantee that is required as seen in Equation 6.

### V. CASE STUDIES

Safety-critical dynamical systems are those where failure could result in catastrophic outcomes, such as loss of life, significant property damage, or harm to the environment. This section presents three safety real world safety critical examples. Each example features a human integrated into the control process and the operational dynamics, as outlined by the HIL-HIP architecture depicted in FIG. 1. The inclusion of humans within the operational framework elevates the criticality of these dynamical systems, significantly increasing the risk of harm. The presence of the human in the plant makes these dynamical systems even more safety-critical where the dynamical system can cause harm to the human very easily. In these cases, the problem of detection of unknown-unknowns is even more important and stops the dynamical system from causing harm.

### A. Automated Insulin Delivery System Example

In the AID system, the glucose insulin dynamics is given by the Bergman Minimal Model (BMM) represented as:

$$δ {i}^{\cdot } ( t ) = - n δ i ( t ) + {p}_{4} {u}_{1} ( t ) \qquad ( 12 )$$

$$δ {i}_{s}^{\cdot } ( t ) = - {p}_{1} δ {i}_{s} ( t ) + {p}_{2} ( δ i ( t ) - {i}_{b} ) \qquad ( 13 )$$

$$δ {G}^{\cdot } ( t ) = - δ {i}_{s} ( t ) {G}_{b} - {p}_{3} ( δ G ( t ) ) + {u}_{2} ( t ) / {V}_{O} I , \qquad ( 14 )$$

The input vector U(t) includes the overnight basal insulin level i_{b} and the glucose appearance rate in the body u₂. The output vector Y(t) includes the blood insulin level i, the interstitial insulin level iₛ, and the blood glucose level G. In AP, only the blood glucose level G is a measurable output. iₛ and i are hidden states that are not measurable but contribute to the final glucose output. p₁, p₂, p₃, p₄, n, and 1/VₒI are all patient specific coefficients.

Consider the unknown-unknown problem of insulin cartridge error in the automated insulin delivery system. In this error, the root cause of the error that is an actuator fault was unknown at the time of error. In terms of FIG. 1, the input to the dynamical system (u+uₑₓₜ) had an error SE caused by the actuator fault. The effect that this error will also have on the dynamical system was also unknown and made this error unknown-unknown at the time of occurrence. The “human being” part of the dynamical system being controlled made measuring the effects even more complicated. While the controller operated under the assumption of flawless insulin administration, the actual delivery to the human body (the plant) was compromised, leading to a significant disparity between the dynamical system's state as perceived by the controller and its true state.

### B. Aircraft Example

Pitch control in a UAV is automated using a Proportional Integrative Derivative (PID) Controller. The pitch control system considers a linear dynamical system model described by Equation 15:

$${\dot{x}}_{α} = {c}_{αα} {x}_{α} + {c}_{α q} {x}_{q} + {c}_{αδ} {u}_{δ} , \\ {\dot{x}}_{q} = {c}_{q α} {x}_{α} - {c}_{qq} {x}_{q} + {c}_{q δ} {u}_{δ} , \\ {\dot{x}}_{θ} = {c}_{θθ} {x}_{q} , y ( t ) = {x}_{θ} . \qquad ( 15 )$$

TABLE III
Physical Model Coefficients Derived for Train and Test Set

| Train/Test | p₁ 1/min | p₂ 1/min | ${p}_{3} \frac{1 {0}^{- 6}}{μ U , {min}^{2}}$ | p₄ | n1/min | Vol dl | G_{b} mg/dl | Residue |
|---|---|---|---|---|---|---|---|---|
| Simulation | 0.098 | 0.1406 | 0.028 | 0.05 | 199.6 | −80 | 0.035 | NA |
| Settings | | | | | | | | |
| Train | 0.0978 | 0.1406 | 0.0262 | 0.0508 | 198.134 | −80.64 | 0.0349 | 0 |
| Test 1 | 0.0982 | 0.1405 | 0.0256 | 0.0530 | 198.1340 | −80.2774 | 0.0329 | 0.0225 |
| 2 | 0.0979 | 0.1407 | 0.0274 | 0.0533 | 198.1340 | −85.0589 | 0.0332 | 0.0028 |
| 3 | 0.0980 | 0.1405 | 0.0262 | 0.0528 | 198.1340 | −85.0973 | 0.0348 | 0.0011 |
| 4 | 0.0981 | 0.1405 | 0.0267 | 0.0515 | 198.1340 | −80.6921 | 0.0343 | −0.0168 |
| 5 | 0.0979 | 0.1407 | 0.0273 | 0.0548 | 198.1340 | −82.7676 | 0.0317 | 0.0328 |
| 6 | 0.0980 | 0.1404 | 0.0275 | 0.0534 | 198.1340 | −82.3447 | 0.0328 | 0.0048 |

Here x_{α} is the angle of attack (AoA), x_{q} is the pitch rate, u_{δ} is the elevator angle, and x_{θ} is the pitch angle of the aircraft. The controller is a PID and based on a pitch angle set point derives the elevator angle u_{δ}. Hence, u_{δ} is the input to the aircraft dynamics, while x_{θ} is the output of the dynamical model. A trajectory is the continuous time value of state variables in between two elevator angle inputs from the PID.

For this example, consider the unknown-unknown MCAS error that caused the accidents in the Boeing 787 aircraft. The cause of this error that is the sensor error of the Angle of Attack sensor was unknown at the time of the error leading to the accident. The effect the error will have on the aircraft (the plant) was also unknown making this error an unknown-unknown. With reference to FIG. 1, the root cause analysis post-accident showed that the error occurred due to a sensor error. The cause was also unknown due to the black box abstraction of the MCAS system. The human who is in the loop the pilot in this case did not know that the faulty AOA sensor was being used to control the plant. The effect of what the error might cause was also unknown and the human perceived a different model of the plant than what the plant was operating under due the faulty sensor. C. Autonomous Driving Example

An autonomous car detects another static car in its lane and attempts to stop before crashing into the car ahead. The kinematics of the car is given by the following equations:

$${\dot{a}}_{x} = - 0.01 {s}_{x} + 0.737 - 0.3 {v}_{x} - 0.5 {a}_{x} , \\ {\dot{v}}_{x} = 0.1 {a}_{x} , {\dot{s}}_{x} = {v}_{x} - 2.5 . \qquad ( 16 )$$

For this example, consider the unknown-unknown error of a zero-day vulnerability in the controller code. The cause of the error which is the code vulnerability was unknown and also the effect of how that vulnerability was unknown. The vulnerability caused the black box controller code to change from f_{c}to f′_{c} in FIG. 1. The effect of the change in the controller was unknown as the human-in-the-loop was unaware of the implementation details of the black box abstraction of the controller code. Originating from a zero-day vulnerability, the full impact on the dynamical system was uncertain, given that this vulnerability had not been detected before.

### VI. EVALUATION METHOD AND METRICS

Unknown unknowns are usually safety-critical, and it is necessary to identify these errors to shield the human participant from harm. The accuracy of the observed unknown-unknown mistakes is the definition of the evaluation metrics for this task. Here, accuracy is defined as the percentage of the identified unknown-unknowns to the total unknown unknowns found in these safety-critical CPS. The approach is designated as Detected (D) if it can identify the Unknown-Unknowns, and Undetected (ND) if it cannot. Following the detection of an unknown-unknown, a forward safety analysis is conducted using the updated model to determine how much time in advance of a safety violation the error can be detected.

### A. Scenario Simulations

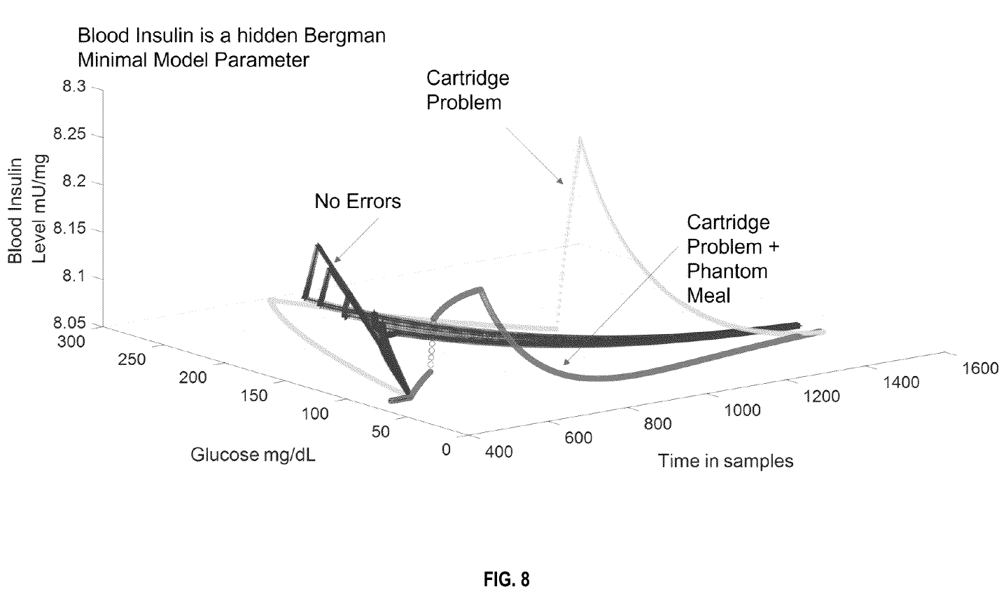

For the AP example, the input set Θ includes information about insulin bolus and meal intake. The set Θ was constructed by varying bolus value from 0 to 40 U while the meal intake was varied from 0 grams to 28 grams as shown in FIG. 8. The trajectories are very different when internal PGSM model variables are considered. The cartridge problem trajectory on glucose would have satisfied STL defined on the output. None of the error trajectories satisfy STL on model coefficients.

The model M(θ) for the AP was the T1D simulator, which is an FDA-approved simulator and widely used for evaluating AP controllers. The subset of θ∈Θ used as sample traces that have no unknown errors given by the following vector:

$$\{ Bolus , Meal \} = \{ ( 12 , 17 ) , ( 28 , 20 ) , ( 7 , 6 ) , ( 14 , 13 ) , ( 17 , 14 ) , \\ ( 32 , 27 ) , ( 15 , 17 ) , ( 20 , 20 ) , ( 10 , 12 ) , ( 12 , 14 ) , ( 25 , 22 ) , ( 5 , 12 ) \} \qquad ( 17 )$$

The PGSM is the BMM discussed in Section V-A with parameter set ω as shown in Table V. The robustness of the STL ϕ for model conformance checking is in Equation 18:

$$ρ ( ϕ , ω ) = {max}_{i ∈ \{ 1 … 7 \}} abs ( \frac{ω [ i ] - {ω}_{sim} [ i ]}{{ω}_{sim} [ i ]} ) - 0.01 , \qquad ( 18 )$$

where ωₛᵢₘ is the T1D simulator settings. The input space {Bolus, Meal} is partitioned into test set I₂={(12, 17), (28, 20), (7, 6), (14, 13), (17, 14), (32, 27)} and train set I₁={(15, 17), (20, 20), (10, 12), (12, 14), (25, 22), (5, 12)}. Section III is used to obtain the parameters ω for the train set as shown in Table III. The residue for each element in the test set is also shown there. Given a probability threshold 1−α=0.95, confidence range d is obtained at position [(6/2+1)*0.95]=4, i.e., d=0.0048. The interval for the robustness value is [−0.0216, 0.0376].

For the Aircraft example, the Maneuvering Characteristics Augmentation System (MCAS) error that was unknown-unknown in the Boeing Max 8 aircraft is replicated to generate test scenarios. In the MCAS system, the Angle of Attack (AoA) sensor is used by supervisory pitch adjustment modules such as to adjust the elevator angle in addition to the PID controller. AoA sensors are considered to be erroneous and hence in any aircraft two AoA sensors (left and right) are utilized for robust AoA determination. However, supervisory control modules such as the MCAS may rely on only one sensor, and as a result, a fault in the sensor can lead to erroneous MCAS pitch trim requests. This can lead to fatal crashes as documented in the flight data recorders obtained from the ill-fated Ethiopian Airlines Boeing Max 8 aircraft. Then, apply the model conformance technique with STL on the model's outputs to identify the instances where deviations occur. Data is generated for different AoA errors occurring at different times. Given the probability threshold 1−α=0.95, the interval obtained for the robustness value is [0.0299, 0.1116]. For the autonomous car example, eleven executions of the normal braking system are considered for various initial sₓ=[30 m to 52 m] and vₓ=[50 mph to 75 mph]. The estimated model parameters are described in Equation 19.

$${\dot{a}}_{x} = - 0.01 {s}_{x} + 0.9 - 0.3 {v}_{x} - 0.506 {a}_{x} , \\ {\dot{v}}_{x} = 0.0911 {a}_{x} , {\dot{s}}_{x} = {v}_{x} - 3.02 . \qquad ( 19 )$$

2000 different validation sets were used with the same initial sₓ and vₓ ranges to compute the residue range of the robustness metric for normal operation, [0.1299, 0].

### B. Unknown-Unknown Scenario Simulation

For the Artificial Pancreas Example, the shunted insulin model is used to generate the traces with the insulin cartridge errors, varying the amount of insulin blockade percent between 20 to 80 percent and the time until insulin release from 50 to 150 mins. The scenarios generated for the insulin cartridge problem are presented in Table V. For the AoA error in the MCAS system, any error or noise rate of 20-25% in the AoA measurement were used to derive the coefficients at the model of the pitch control system. For the autonomous vehicle example, an integer overflow vulnerability in the control software is considered where instead of declaring Q as an uint6_t variable it is mistakenly defined as int8_t. This means that instead of setting Q(1,1)=10, 000, it is now set at Q(1,1)=16. This can potentially cause a crash since the controller is less aggressive. The PGSM STL has the same form as Equation 18.

### C. Baseline Strategy

Baseline1: We replicate a model conformance-based strategy from a previous study to the best of our knowledge. In the work, the authors learn a surrogate model of the dynamical system under test and use it to find the robustness range of the output values. During operation, a new model is learned from the test traces and checked if the robustness values lie within the robustness range. If the robustness value of the test system is outside the range then the dynamical system under test is termed to have deviated from the approved characteristics.

Baseline2: We also replicate an online hybrid monitor; in particular, the STL learning technique was implemented for the AP and autonomous braking case study using the same STL structures.

### D. Time To Failure Estimation

Time to Failure is the time until which the dynamical system is safe or doesn't violate any safety certificates or properties. After an unknown-unknown is detected, forward simulation can be performed with the recovered model to estimate the time to failure. For simplicity, assumptions can be made including: (1) that the model is time-invariant from the detection of the unknown-unknown till the time to failure; and (2) that there is no new external (uₑₓₜ) or internal (u) inputs (FIG. 1) to the dynamical system from the detection time to the time to actual failure. One aim of the methods outlined herein is to detect the unknown-unknowns at d such that d<(T_{failure}−Λ), where T_{failure} is the time at which the dynamical system violates the Safety STL of the dynamical system and Λ is the time to perform the mitigating actions to stop the error. The Safety STL is the STL on the output variables and defines the safety properties of the dynamical system. In the case of the AID example discussed in Section V-A, an STL on output can be defined such that the output (glucose) should always be below 180 and above 70. If an unknown-unknown is detected, then a human user should have enough time to mitigate the error. For AID the mitigating actions can be like drinking a glass of orange juice which takes around 15 mins to have an effect on blood glucose. So, any error which is detected before 15 mins from the time to failure will allow enough time to the human to avoid fatal consequences.

To estimate the time to failure, the following steps can be applied:
Detection of unknown-unknown.
If any unknown-unknown is detected at time step d then mine the PGSM model M′ till that time step.
Forward simulate with M′ (time-invariant assumption) until there is a violation of the STL properties.
STL violation is detected at time step T_{failure}.
Verify that d<(T_{failure}−Λ).

### VII. RESULTS

### A. Automated Insulin Delivery System Example

Table V shows that for the insulin cartridge problem, the model conformance results show that the robustness values under various input configurations are falling outside the range. Hence, these scenarios are deemed to be non-conformal to the original model. A look at the trajectory will show that although the glucose level did not cross the STL-specified thresholds trajectories with unknown and known errors were very different from the trajectory for no error as shown in FIG. 8 in terms of the hidden model variables. As such these output trajectories will all satisfy the STL if it was evaluated on the output. However, since the methods outlined herein evaluate the STL robustness on the PGSM coefficients, the change can be detected. Using the methods outlined herein, all the unknown-unknown errors that were simulated for evaluation were successfully detected. Furthermore, when performing the time-to-failure estimation, this method—applying Signal Temporal Logic (STL) to the model coefficients of PGSM—was able to identify unknown-unknowns approximately 175±19.54 time samples before the actual failure occurred. This provided sufficient lead time to implement mitigative actions.

TABLE IV
Traces Obtained from Scenario Simulation.

| | Initial | | | Sample |
|---|---|---|---|---|
| Application | Conditions | Samples | Input Configuration | s/sec |
| Artificial | X = 0, | 1500 | u₁ square wave from | 1/60 |
| Pancreas | I = 8.052, | | sample 550 to 600, u₂ | |
| | G = 170 | | square wave from | |
| | | | sample 500 to 650 | |
| Aircraft Pitch | xₐ = 0, | 200,000 | AoA set point u_{δ} | 1e−⁴ |
| Control System | x_{q} = 0, | | change at t = 0 from | |
| | x_{θ} = 0 | | 0° to 10° | |
| Autonomous | vₓ = 5, | 300 | step input u at t = 0 of | 10 |
| Vehicle Lane | sₓ = −10, | | 0.1 rads/sec | |
| Change System | aₓ =0.1, | | | |
| | w = 0, | | | |
| | v_{y} = 0, | | | |
| | s_{y} = 0 | | | |

### B. Aircraft Example

As shown in Table VI, the model conformance with STL on the model outputs failed to recognize such deviations as the outputs fell within the defined safe and robust range. In contrast, the unknown-unknown detection technique of applying model conformance to the model's parameters as outlined herein successfully identified such deviations immediately upon their occurrence. The methods outlined herein were able to detect the errors before the errors were observable on the output characteristics.

### C. Autonomous Driving Example

11 simulations of the autonomous braking system were conducted, using the data to train a deep learning model for assessing the reliability of the dynamical system's output. Subsequently, an additional 11 simulations were conducted introducing braking errors. The vulnerable controller code was executed to obtain the traces starting from the same initial sₓ and vₓ as training. The average robustness residue is −17.395 (±2.1), with all vulnerable traces falling outside the robustness range. The proposed STL method on the model's parameters detected all 11 errors.

### VIII. INTEGRATION INTO AUTOMATED SAFETY ASSURANCE TOOL CHAIN

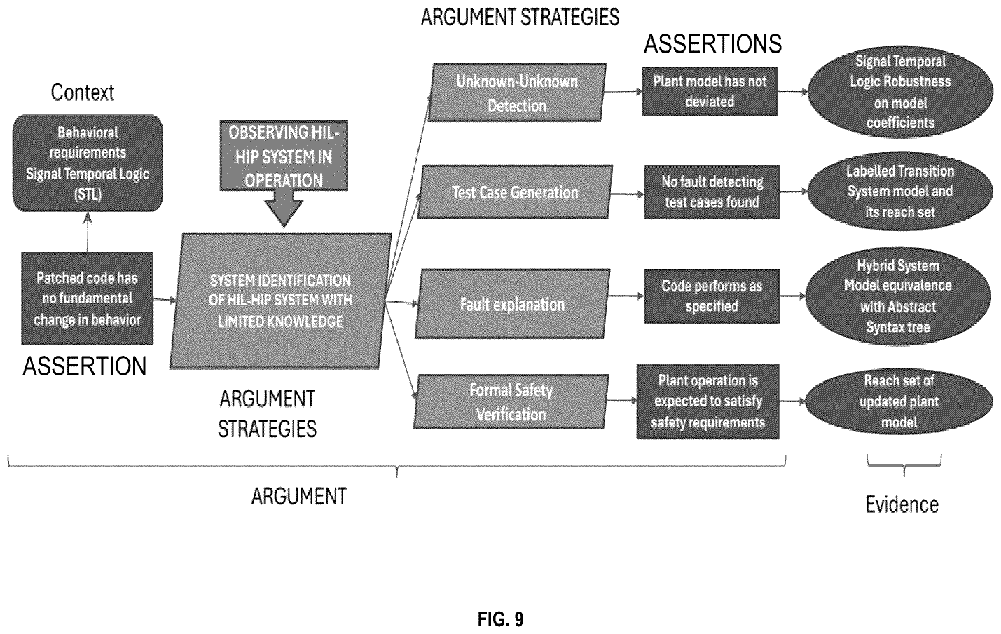

This unknown-unknown detection method can be seamlessly incorporated into the toolchain for generating assurance cases during patch verification (FIG. 9). During operation, if software malfunctions, the code is patched with Over the Air updates. There is an increasing need to verify the safety of these safety critical dynamical systems under the influence of the new patch. This toolchain generates assurance cases by aligning them with specific assertions and demonstrating evidence-based satisfaction of these assertions through various argument strategies whether a patch in the code causes any fundamental behavior change. For instance, in the case of autonomous vehicles, if a bug is detected, the manufacturer might issue a patch and deploy it via over-the-air updates. It is crucial to verify and argue that the vehicle, post-patch, continues to operate as intended without deviating from its designed behavior. The unknown-unknown detection mechanism can serve as one of these strategies, determining if the operational model with the applied patch deviates from the safety-certified model of the dynamical system. If there is no deviation, the assurance case generation toolchain can use this evidence as a basis for its arguments. A safety-certified model is one that has been thoroughly verified and validated against different safety constraints. Using such deviations as a basis for argumentation, the toolchain can assert whether or not the patch has induced any fundamental changes in the model's behavior.

### IX. CONCLUSIONS

The present disclosure outlines a stochastic model conformance evaluation framework that can determine whether an operational trace conforms to the original AI-enabled Human-in-Loop Human-in-plant model behavior. The method includes monitoring the physical dynamical system and models its behavior using a physics-guided surrogate model. A deviation in the evaluation criteria for model conformance between the original HIL-HIP system coefficients and operational model coefficients results in the detection of operational changes. The techniques outlined herein were found to identify unknown errors whose effects are hidden in the inner parameters of the CPS with minimal effect on the observable outputs. Early detection of such errors using this technique can potentially prevent future fault combinations that can potentially have fatal consequences. The detection accuracy of the method is highly depended on the training and the testing traces used to learn the model coefficients and the overall effects of the training data available to the detection accuracy needs to be farther investigated. Post detection of errors the dynamical system can mitigate the unknown-unknown errors in several ways. Upon detection of unknown-unknown errors, the dynamical system can initiate corrective measures by either handing control back to the human operator or by executing a predefined set of safe actions to mitigate the impact of these unknown-unknown errors. Finding these safe sets of actions for different types of unknown-unknowns remains a part of future research direction and is yet unanswered. Although existing error mitigation techniques are applicable, more research is necessary to determine how effective they are in this situation.

### X. METHOD

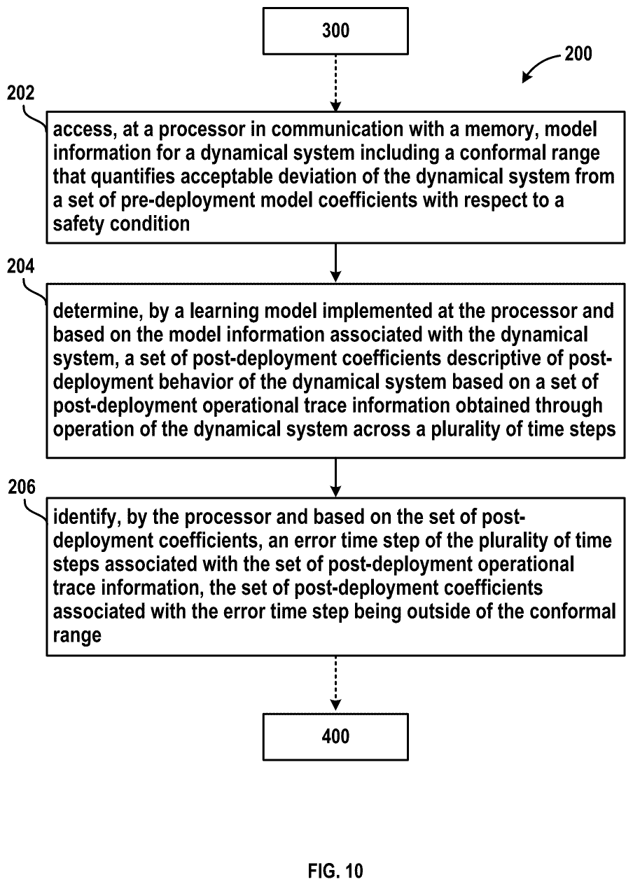

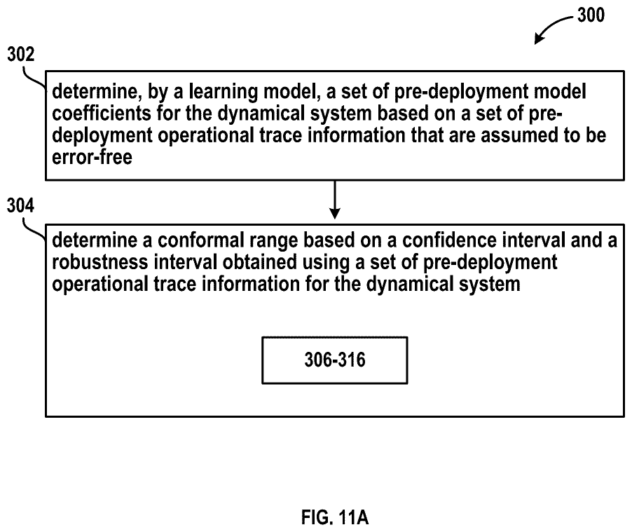

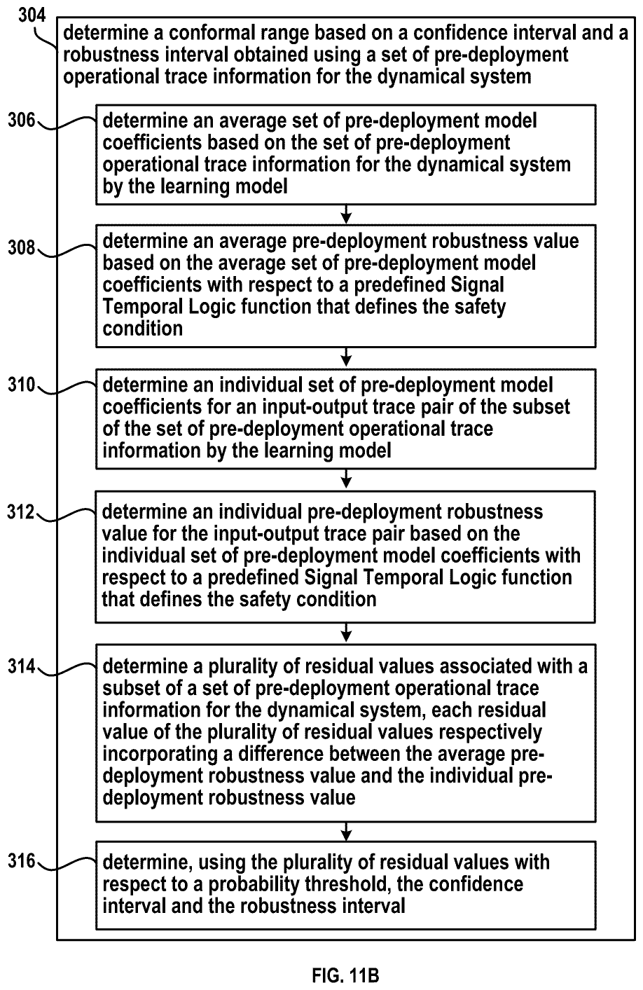

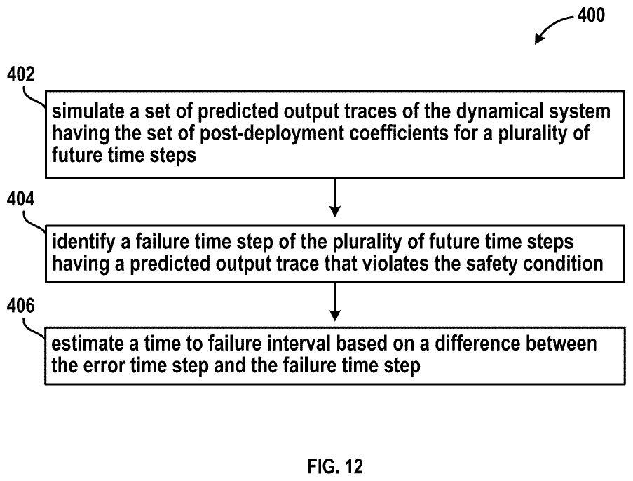

With reference to FIGS. 10-12, a first computer-implemented method 200 shown in FIG. 10 can be preceded by a second computer-implemented method 300 shown in FIGS. 11A and 11B, and can be followed by a third computer-implemented method 400 shown in FIG. 12. The methods shown in FIGS. 10-12 can collectively implement aspects of framework 100 shown in FIG. 4.

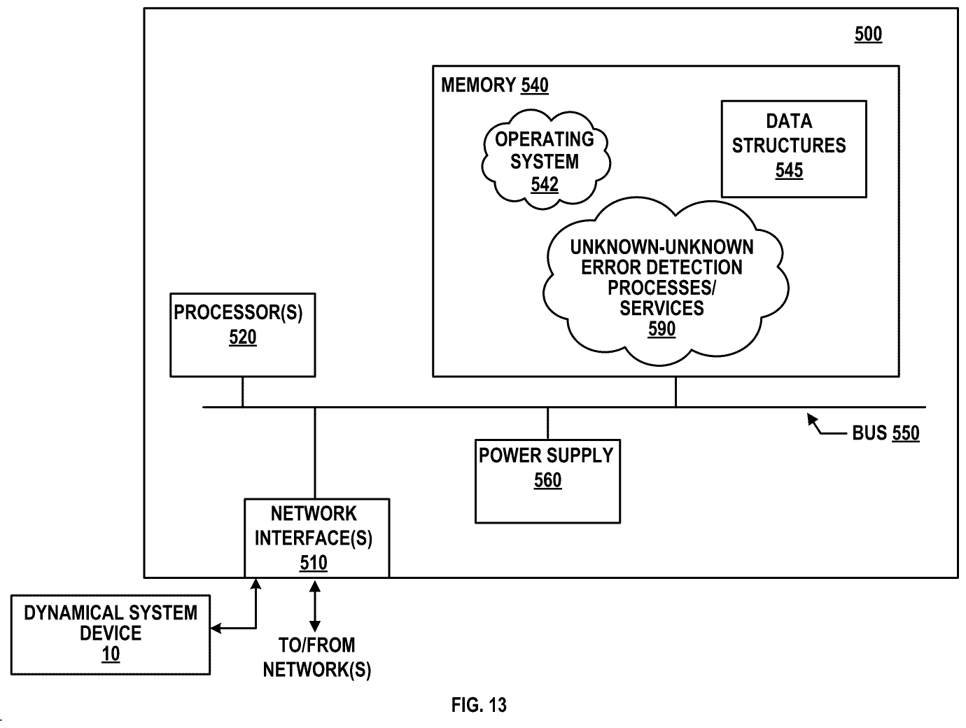

The first computer-implemented method 200 of FIG. 10 (hereinafter, “method 200”) can be implemented at a computing device such as device 500 of FIG. 13 which may be in communication with a device implementing the dynamical system. Method 200 is concerned with evaluating a conformity of a post-deployment model of a dynamical system to a safety condition based on post-deployment model coefficients and identifying an error time step.

Step 202 of method 200 includes accessing, by a processor, model information for a pre-deployment model of a dynamical system, including a predefined Signal Temporal Logic function (ϕ) that defines a safety condition and a conformal range ([ρₘᵢₙ−d, ρₘₐₓ+d] where ρₘₐₓ=max_{θ}_{ᵢ}_{∈Θ}(ρ(ϕ, ωᵢ)) and ρₘᵢₙ=min_{θ}_{ᵢ}_{∈Θ}(ρ(ϕ, ωᵢ))) that quantifies acceptable behavioral deviation of the dynamical system from a set of pre-deployment model coefficients (ω) with respect to the safety condition. Importantly, the conformal range incorporates a robustness value (ρ) that quantifies a degree to which the set of post-deployment model coefficients (ω) satisfy the safety condition for the dynamical system, the safety condition being associated with a predefined Signal Temporal Logic function (ϕ).

Step 204 of method 200 includes determining, by a learning model (L) implemented at the processor and based on the model information associated with the dynamical system, a set of post-deployment coefficients (ω) descriptive of post-deployment behavior of the dynamical system based on a set of post-deployment operational trace information obtained through operation of the dynamical system across a plurality of time steps. The learning model (L) is trained to apply a Physics Guided Surrogate Modeling (PGSM) technique that determines the set of post-deployment coefficients (ω) for the dynamical system based on a set of post-deployment operational trace information including a set of input traces (θ) and a set of output traces (ζ_{θ}) associated with the dynamical system.

Step 206 of method 200 includes identifying, by the processor and based on the set of post-deployment coefficients (ω), an error time step of the plurality of time steps associated with the set of post-deployment operational trace information, the set of post-deployment coefficients associated with the error time step being outside of the conformal range. The error time step can be used to generate warnings and other intervention measures to maintain safety of the dynamical system, and can be used to estimate a “time to failure” interval (see the third computer-implemented method 400 of FIG. 12).

The second computer-implemented method 300 of FIGS. 11A and 11B (hereinafter, “method 300”) can be implemented at a computing device such as device 500 of FIG. 13, and may be implemented by a manufacturer based on ideal model behavior of the dynamical system prior to deployment of the post-deployment model discussed herein with respect to method 200 of FIG. 10. Method 300 is concerned with obtaining model information for the pre-deployment model of the dynamical system including the conformal range that enables safety evaluation of the post-deployment model.

Step 302 of method 300 shown in FIG. 11A includes determining, by a learning model (L) implemented at a processor, the set of pre-deployment model coefficients (ω) for the dynamical system based on a set of pre-deployment operational trace information (which can be assumed to be error-free).

The set of pre-deployment model coefficients (ω) can correspond with a joint probability distribution of a set of sample input traces (θ) of the set of pre-deployment operational trace information and a set of pre-deployment robustness values (ρ(ϕ, ω)) over a sample input space (Θ).

The learning model (L) is trained to apply a Physics Guided Surrogate Modeling (PGSM) technique that determines a the set of pre-deployment model coefficients (ω) for the dynamical system based on a set of pre-deployment operational trace information including a set of input traces (θ) and a set of output traces (ζ_{θ}) associated with the dynamical system.

Step 304 of method 300 shown in FIG. 11A and expanded upon in FIG. 11B includes determining the conformal range ([ρₘᵢₙ−d, ρₘₐₓ+d] where ρₘₐₓ=max_{θ}_{ᵢ}_{∈Θ}(ρ(ϕ, ωᵢ)) and ρₘᵢₙ=min_{θ}_{ᵢ}_{∈Θ}(ρ(ϕ, ωᵢ))) based on a confidence interval (d) and a robustness interval ([ρₘᵢₙ, ρₘₐₓ]) obtained using a set of pre-deployment operational trace information for the dynamical system.

Step 304 for obtaining the conformal range can be expanded into steps 306-316 shown in FIG. 11B.

Step 306 of method 300 includes determining an average set of pre-deployment model coefficients (ω) based on a first subset (I₁) of the set of pre-deployment operational trace information for the dynamical system by the learning model (L).

Step 308 of method 300 includes determining an average pre-deployment robustness value (ρ(ω)) based on the average set of pre-deployment model coefficients (ω) with respect to the predefined Signal Temporal Logic function (ϕ) that defines the safety condition.

Step 310 of method 300 includes determining an individual set of pre-deployment model coefficients (ωᵢ) for an input-output trace pair of a second subset (I₂) of the set of pre-deployment operational trace information by the learning model (L).

Step 312 of method 300 includes determining an individual pre-deployment robustness value (ρ(ωᵢ)) for the input-output trace pair based on the individual set of pre-deployment model coefficients (ωᵢ) with respect to a predefined Signal Temporal Logic function (ϕ) that defines the safety condition.

Step 314 of method 300 includes determining a plurality of residual values (ρ(ω)−ρ(ωᵢ)) associated with the second subset (I₂) of a set of pre-deployment operational trace information for the dynamical system, each residual value (ρ(ω)−ρ(ωᵢ)) of the plurality of residual values respectively incorporating a difference between an average pre-deployment robustness value (ρ(ω)) and an individual pre-deployment robustness value (ρ(ωᵢ)).

Step 316 of method 300 includes determining, using the plurality of residual values with respect to a probability threshold, the confidence interval (d) and the robustness interval ([ρₘᵢₙ, ρₘₐₓ]).

The third computer-implemented method 400 of FIG. 12 (hereinafter, “method 400”) can be implemented at a computing device such as device 500 of FIG. 13, and may be implemented to estimate a “time to failure” interval following identification of the error time step at Step 206 of method 200 shown in FIG. 10.

Step 402 of method 400 includes simulating a set of predicted output traces of the dynamical system having the set of post-deployment coefficients for a plurality of future time steps. Step 404 of method 400 includes identifying a failure time step of the plurality of future time steps having a predicted output trace that violates the safety condition. Step 406 of method 400 includes estimating the time to failure interval based on a difference between the error time step and the failure time step.

In some examples, the dynamical system is an HIL-HIP system that incorporates unmodeled control inputs of a user and unmodeled system dynamics associated with the user.

The dynamical system can be an automated insulin delivery system, the set of post-deployment operational trace information being measurable by one or more sensors and having input traces that include an overnight basal insulin level and a glucose appearance rate and having output traces that include a blood glucose level, the dynamical system incorporating unmodeled control inputs of a user to the automated insulin delivery system and unmodeled system dynamics associated with a physiology of the user that affect correlation between the input traces and the output traces.

Alternatively, the dynamical system can include a vehicle control system, the set of post-deployment operational trace information being measurable by one or more sensors and having input traces that include an input control value and having output traces that include an output control value. For example, the vehicle control system can be an aircraft pitch control system, where the input control value is an elevator angle and the output control value is a pitch angle. In another example, the vehicle control system can be an autonomous vehicle braking system, the input control value correlating with a braking control value and the output control value correlating with vehicle kinematics.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

### XI. COMPUTER IMPLEMENTED SYSTEM

FIG. 13 is a schematic block diagram of an example device 500 that may be used with one or more embodiments described herein, e.g., as a part of, in communication with or otherwise associated with a dynamical system device 10 and implementing aspects of framework 100 shown in FIG. 4 and one or more of methods 200, 300, and 400 shown in FIGS. 10-12.

Device 500 comprises one or more network interfaces 510 (e.g., wired, wireless, PLC, etc.), at least one processor 520, and a memory 540 interconnected by a system bus 550, as well as a power supply 560 (e.g., battery, plug-in, etc.).

Network interface(s) 510 include the mechanical, electrical, and signaling circuitry for communicating data over the communication links coupled to a communication network. Network interfaces 510 are configured to transmit and/or receive data using a variety of different communication protocols. As illustrated, the box representing network interfaces 510 is shown for simplicity, and it is appreciated that such interfaces may represent different types of network connections such as wireless and wired (physical) connections. Network interfaces 510 are shown separately from power supply 560, however it is appreciated that the interfaces that support PLC protocols may communicate through power supply 560 and/or may be an integral component coupled to power supply 560.

Memory 540 includes a plurality of storage locations that are addressable by processor 520 and network interfaces 510 for storing software programs and data structures associated with the embodiments described herein. In some embodiments, device 500 may have limited memory or no memory (e.g., no memory for storage other than for programs/processes operating on the device and associated caches). Memory 540 can include instructions executable by the processor 520 that, when executed by the processor 520, cause the processor 520 to implement aspects of the systems and the methods (e.g., methods 200, 300, and 400) outlined herein.

Processor 520 comprises hardware elements or logic adapted to execute the software programs (e.g., instructions) and manipulate data structures 545. An operating system 542, portions of which are typically resident in memory 540 and executed by the processor, functionally organizes device 500 by, inter alia, invoking operations in support of software processes and/or services executing on the device. These software processes and/or services may include unknown-unknown error detection processes/services 590, which can include aspects of methods 200, 300, and 400 and/or implementations of various modules described herein. Note that while unknown-unknown error detection processes/services 590 is illustrated in centralized memory 540, alternative embodiments provide for the process to be operated within the network interfaces 510, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the unknown-unknown error detection processes/services 590 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method, comprising:
accessing, at a processor in communication with a memory, model information for a dynamical system including a conformal range that quantifies acceptable deviation of the dynamical system from a set of pre-deployment model coefficients with respect to a safety condition;
determining, by a learning model implemented at the processor and based on the model information associated with the dynamical system, a set of post-deployment model coefficients descriptive of post-deployment behavior of the dynamical system based on a set of post-deployment operational trace information obtained through operation of the dynamical system across a plurality of time steps; and
identifying, by the processor and based on the set of post-deployment model coefficients, an error time step of the plurality of time steps associated with the set of post-deployment operational trace information, the set of post-deployment model coefficients associated with the error time step being outside of the conformal range.

2. The method of claim 1, the conformal range incorporating a robustness value that quantifies a degree to which the set of post-deployment model coefficients satisfy the safety condition for the dynamical system, the safety condition being associated with a predefined Signal Temporal Logic function.

3. The method of claim 1, the dynamical system incorporating unmodeled control inputs of a user and unmodeled system dynamics associated with the user.

4. The method of claim 1, the dynamical system being an automated insulin delivery system, the set of post-deployment operational trace information being measurable by one or more sensors and having input traces that include an overnight basal insulin level and a glucose appearance rate and having output traces that include a blood glucose level, the dynamical system incorporating unmodeled control inputs of a user to the automated insulin delivery system and unmodeled system dynamics associated with a physiology of the user that affect correlation between the input traces and the output traces.

5. The method of claim 1, the dynamical system including a vehicle control system, the set of post-deployment operational trace information being measurable by one or more sensors and having input traces that include an input control value and having output traces that include an output control value.

6. The method of claim 5, the vehicle control system being an aircraft pitch control system, the input control value being an elevator angle and the output control value being a pitch angle.

7. The method of claim 5, the vehicle control system being an autonomous vehicle braking system, the input control value correlating with a braking control value and the output control value correlating with vehicle kinematics.

8. The method of claim 1, further comprising:
simulating a set of predicted output traces of the dynamical system having the set of post-deployment model coefficients for a plurality of future time steps; and
identifying a failure time step of the plurality of future time steps having a predicted output trace that violates the safety condition.

9. The method of claim 8, further comprising:
estimating a time to failure interval based on a difference between the error time step and the failure time step.

10. The method of claim 1, the model information for the dynamical system including a predefined Signal Temporal Logic function that defines the safety condition.

11. The method of claim 1, further comprising:
determining, by a learning model implemented at the processor, the set of pre-deployment model coefficients for the dynamical system based on a set of pre-deployment operational trace information that are assumed to be error-free;
the set of pre-deployment model coefficients corresponding with a joint probability distribution of a set of sample input traces of the set of pre-deployment operational trace information and a set of pre-deployment robustness values over a sample input space.

12. The method of claim 1, further comprising:
determining a conformal range based on a confidence interval and a robustness interval obtained using a set of pre-deployment operational trace information for the dynamical system.

13. The method of claim 12, further comprising:
determining a plurality of residual values associated with a subset of a set of pre-deployment operational trace information for the dynamical system, each residual value of the plurality of residual values respectively incorporating a difference between an average pre-deployment robustness value and an individual pre-deployment robustness value; and
determining, using the plurality of residual values with respect to a probability threshold, the confidence interval and the robustness interval.

14. The method of claim 13, further comprising:
determining an average set of pre-deployment model coefficients based on the set of pre-deployment operational trace information for the dynamical system by the learning model; and
determining the average pre-deployment robustness value based on the average set of pre-deployment model coefficients with respect to a predefined Signal Temporal Logic function that defines the safety condition.

15. The method of claim 13, further comprising:
determining an individual set of pre-deployment model coefficients for an input-output trace pair of the subset of the set of pre-deployment operational trace information by the learning model; and
determining the individual pre-deployment robustness value for the input-output trace pair based on the individual set of pre-deployment model coefficients with respect to a predefined Signal Temporal Logic function that defines the safety condition.

16. The method of claim 1, the learning model being trained to apply a Physics Guided Surrogate Modeling (PGSM) technique that determines a set of model coefficients for the dynamical system based on a set of operational trace information including a set of input traces and a set of output traces associated with the dynamical system.

17. A method, comprising:
determining, by a learning model implemented at a processor, a set of pre-deployment model coefficients for a dynamical system based on a set of pre-deployment operational trace information, the set of pre-deployment model coefficients corresponding with a joint probability distribution of a set of sample input traces of the set of pre-deployment operational trace information and a set of pre-deployment robustness values over a sample input space, the learning model being trained to apply a Physics Guided Surrogate Modeling (PGSM) technique;
determining a conformal range based on a confidence interval and a robustness interval obtained using a set of pre-deployment operational trace information for the dynamical system, the conformal range quantifying acceptable deviation of the dynamical system from the set of pre-deployment model coefficients with respect to a safety condition associated with a predefined Signal Temporal Logic function; and
providing the set of pre-deployment model coefficients and the conformal range as model information to a computing device associated with the dynamical system.

18. The method of claim 17, further comprising:
determining, by a learning model implemented at a computing device associated with the dynamical system and based on the model information associated with the dynamical system, a set of post-deployment model coefficients descriptive of post-deployment behavior of the dynamical system based on a set of post-deployment operational trace information obtained through operation of the dynamical system across a plurality of time steps; and
identifying, by the processor and based on the set of post-deployment model coefficients, an error time step of the plurality of time steps associated with the set of post-deployment operational trace information, the set of post-deployment model coefficients associated with the error time step being outside of the conformal range;
the conformal range incorporating the robustness value that quantifies a degree to which the set of post-deployment model coefficients satisfy the safety condition for the dynamical system.

19. The method of claim 17, further comprising:
determining a plurality of residual values associated with a subset of a set of pre-deployment operational trace information for the dynamical system, each residual value of the plurality of residual values respectively incorporating a difference between an average pre-deployment robustness value and an individual pre-deployment robustness value; and
determining, using the plurality of residual values with respect to a probability threshold, the confidence interval and the robustness interval.

20. A system, comprising:
a processor in communication with a memory and a dynamical system device, the memory including instructions executable by the processor to:
access model information for a dynamical system including a conformal range that quantifies acceptable deviation of the dynamical system from a set of pre-deployment model coefficients with respect to a safety condition;
determine, by a learning model and based on the model information associated with the dynamical system, a set of post-deployment model coefficients descriptive of post-deployment behavior of the dynamical system based on a set of post-deployment operational trace information obtained through operation of the dynamical system across a plurality of time steps; and
identify, based on the set of post-deployment model coefficients, an error time step of the plurality of time steps associated with the set of post-deployment operational trace information, the set of post-deployment model coefficients associated with the error time step being outside of the conformal range.
